(19) United States
(12) Patent Application Publication
(10) Pub. No.: US 2011/0090083 A1
(43) Pub. Date: Apr. 21, 2011

(54) Systems and methods of searching based on trademarks

(76) Inventor: Rodger H. Rast, Gold River, CA (US)

(21) Appl. No.: 10/891,718

(22) Filed: Jul. 14, 2004

Related U.S. Application Data
(60) Provisional application No. 60/487,295, filed on Jul. 14, 2003.
(60) Provisional application No. 60/526,376, filed on Dec. 1, 2003.

(51) Int. Cl. G08B 13/00; G06F 17/30; G08B 21/00; H04M 3/42; B62M 9/134; B62M 25/02

(52) U.S. Cl. 340/541; 707/706; 340/540; 707/748; 379/201.01; 474/80

(57) ABSTRACT

A system and method of searching the world wide web for relevant web sites by a user. The system provides a means for indexing relationship information, such as owners of trademarks, in the search engine and retrieval thereof. The user can select particular relationship elements to rank at the top of the web list, and/or the search engine can automatically retrieve one or more categories of relationship information. New classes of META tags are defined in one embodiment for supporting the invention while third party data can be utilized, or in conjunction with META tag information.

### CROSS-REFERENCE TO RELATED APPLICATIONS

This application claims priority from U.S. provisional application Ser. No. 60/487,295 filed on Jul. 14, 2003;

provisional patent application docket number PPA_RAST120103 application No. 60/526,376 filed Dec. 1, 2003;

regular patent application Ser. No. 10/612,777 filed Jul. 1, 2003 and prior patent application Ser. No. 60/394,160 filed Jul. 1, 2002;

regular patent application Ser. No. 10/670,432 filed Sep. 23, 2003, and related provisional patent application No. 60/413,199 filed Sep. 23, 2002;

regular patent application Ser. No. 10/245,909 filed Sep. 15, 2002 as docket “TipTracker_{—}02”; and provisional application Ser. No. 60/413,199 filed Sep. 23, 2002;

each of the above is incorporated herein by reference and priority is claimed to each of the foregoing applications.

### STATEMENT OF FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

This invention pertains generally to internet searching methods and more particularly to a method of ranking search results.

2. Description of the Background Art

Searching on the web by keywords has become an important tool for both business and personal reasons. Unfortunately, our searches rank the sites that link to, comment on, review, or describe, the site we are really interested in, leaving us to scan through often hundreds, thousands, or even millions of hits to find the “real” site of interest.

Conventional search engines index the content of the web sites in a databases that is queried to fulfill a search request. The content of the web pages in a site are indexed, typically along with title and keyword META tag information. However, web site promoters can include any information they want on their site and in the title and keyword META tags to draw viewers to their site. In some cases this is even done to the extent to draw users away from “official” sites to the promoter site.

Newer search engines have in some cases maintained information about the popularity of sites, so as to aid the user in gauging the results, however, this method still does not solve the typical problems.

As can be seen, therefore, the development of a method and system of ranking web sites in a search based on official information, such as trademark ownership, and other forms of relationships, would speed user searches.

Therefore a need exists for a relationship based search engine, that can rank results based on user selected relationship criterion. The search engine in accordance with the present invention satisfies that need, as well as others, and overcomes deficiencies in previously known techniques.

### BRIEF SUMMARY OF THE INVENTION

The present invention provides a system and method by which searches based on name key words, such as product names, business names, and so forth, can provide results more in line with the desires of the searcher. The invention utilizes tags within the web file that direct a search to the type of “ownership” claim and an associated string describing what is “owned”. Search engines modified according to aspects of the invention incorporate features which key off of the tags to speed searching. It will be appreciated that web sites are traditionally written in a combination of HTML, XML, JAVA scripts, cgi scripts and so forth. The tags may be implemented as META tags or any other convenient tagging mechanism.

Current META tags being utilized include the following:

<META name=Description content=“description line”>

<META name=Keywords content=“keyword listing”>

<META name=Title content=“title of page”>

The present invention expands that list so that owners may indicate their rights in a name—and allow searchers to base a search on those name rights, thereby separating those who are merely linking to the site with those who have some form of right to claim that status.

It will be appreciated that the advantages of relationship searching are best utilized on conjunction with traditional search engine functionality. It would be less preferable to create web sites which provided specific forms of “official” information. Furthermore, the user would then be subject to the bias of the web site originator providing this wherein only authorized trademark owners can be listed.

The present invention generally describes a method of finding web sites with a specific relationship or association with the search string (i.e. official sites and trademark owner sites), comprising. (a) Adding a META tag type to a web site for an organization or individual. The META tag reciting a specific ownership relation or association with the trademarked text. (b) Adding descriptive text within the variable text field of the META tag that fulfills the specific ownership relation or association for the organization or individual. (c) Making the web site available for searching by search engines configured for searching the META tag type which recites the specific ownership relation or association.

The method of searching a collection of web sites for a user-supplied text search string according to the invention generally comprises. (a) Entering a search string by a user. (b) Activating text search programming or search engine acting upon a collection of web site information or web sites accessible on the Internet. (c) Text searching for the search string within the variable text field of a META tag reciting a specific ownership relation or association within the name text field. (d) Displaying information about web sites in which the search string was found in the variable text field of a META tag reciting a specific ownership relation or association, and information about the specific ownership relation or association that matched the search string entered by the user.

Further the method can include selecting one or more ownership relationship or associations to which the search results for the user entered search string are to be responsive. The search programming or search engine can be configured to search only META tag types reciting said one or more ownership relationships or associations. The search engine programming or search engine can be configured to search META tag types reciting the specified ownership relationship or associations along with other web site fields. The search engine or its programming can be configured for generating search results which are ranked by how the search string matches with the variable text field within a META tag type that recites one or more of the specified ownership relationship or associations. The search programming can be configured for generating search results wherein information displayed for web sites in which the user search string matched with the variable text field within a META tag type, reciting one or more of the specified (or implicated) ownership relationship or associations, contains information about the ownership relationship or association recited by the META tag.

The invention also describes ranking affiliated sites using a META tag denoting “an affiliate site”—these having a bonafide affiliate relationship to a trademarked name. Optionally, the site owning the trademark can provide a list of site names under each category, wherein those using the names can be readily checked by the search engine with sites not listed by the TM owner being flagged, dropped from the results, or moved toward the end of the result list.

Other forms of tags may also be created according to the invention which aver to some specific (preferably easily verifiable) ownership relationship (i.e. Trademark, Patent, Copyright, Right to use, or relationship with regard thereto), or associations (i.e. designation, location, etc.) or other items for which a search may be constructed.

The present invention also generally describes a method of finding web sites with a specific association with the search string, comprising. (a) Obtaining at least one list of information and/or ranking of entities associated with specified web sites by a search engine. (b) Adding search selection criterion for user selection which depend on information from the list obtained. (c) Listing web sites found during the search in an order responsive to information which was obtained from one of the lists.

The present invention may be implemented in a number of ways and provides numerous aspects, including but not limited to the following.

An aspect of the invention is to facilitate searching of the Internet for products, business, services, and the like which are have a given association with a trademark, business owner, or other bonafide entity to the relationship.

Another aspect of the invention is to provide ordering of search results based on relationships and subrelationships between entities.

Another aspect of the invention is to provide ordering of search results based on their “official nature” in association with the key words, such as Trademark owner, manufacturer, official retailer, and so forth.

Another aspect of the invention is to provide access to a database of relationships, which are accessed by the search engine for selecting official sites.

Another aspect of the invention is to provide access to search entities based on rankings, locations, associations, and so forth as received from third party entities, such as business research companies, magazines, and the like (i.e. Business lists, “list of top 100 businesses”, “Forbes 500”, etc.).

Another aspect of the invention is to rank sites in response to the specificity of the content contained therein.

Another aspect of the invention is to provide a number of relationship forms, such as “adverse”, “content specificity”, “non-link site specificity”, and so forth.

Another aspect of the invention is to utilize relationship information received from third party providers within the ranking criterion.

Further aspect and advantages of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings which are for illustrative purposes only:

FIG. 1 is a block diagram of relationship searching according to an embodiment of the present invention.

FIG. 2 is a screenshot example of a search engine interface according to an aspect of the present invention.

FIG. 3 is a flow chart of indexing web sites according to an aspect of the present invention.

FIG. 4 is a flow chart of searching an indexed web database containing relationship information according to an aspect of the present invention.

FIG. 5 is a side view of an articulated arm according to an aspect of the present invention, showing center position A along with actuated positions B, B′, C, and C′ as examples of the range of motion provided.

FIGS. 6-9 are image views which are corrected according to an aspect present invention.

FIG. 10 is a facing view of a camera having a motor driven rotation drive according to an aspect of the present invention, such as for mounting on the articulated arm of FIG. 5.

FIG. 11 is a side view of a camera having a muscle wire rotation drive according to an aspect of the present invention, such as for mounting on the articulated arm of FIG. 5.

FIG. 12 is a schematic of a linear muscle drive circuit according to an aspect of the present invention, showing the use of a action sense means.

FIG. 13 is a schematic of a digital muscle drive circuit according to an aspect of the present invention, showing the use of a calibration phase sensor and non-volatile memory for retaining correction factors.

FIG. 14 is a perspective view of an articulated muscle wire driven arm according to an aspect of the present invention, shown with bead cross-sections which encourage movement along fixed directions.

FIG. 15 is a top view of one “bead” within the articulated arm of FIG. 14 according to an aspect of the present invention.

FIG. 16 is a side view of a single axis “bead” according to an aspect of the present invention for constraining movement to a single axis.

FIG. 17 is a top view of the single axis “bead” of FIG. 16.

FIG. 18 is a perspective view of a sheathed polymeric muscle wire according to an aspect of the present invention, showing a muscle wire loop coupled to a movable load.

FIG. 19 is a schematic of a preponderance of evidence (PROE) alarm system according to an embodiment of the invention, showing logic of generating alarm state output although neither individual sensor has crossed a valid alarm threshold.

FIG. 20 is a schematic of a PROE alarm system according to another embodiment of the invention, showing the use of a variety of sensors within the logic of the system.

FIG. 21 is a schematic of a PROE alarm system according to another embodiment of the invention, showing summing of various PROE signals.

FIG. 22 is a block diagram of a reprogrammable electric stamp for marking electronic ink and other materials according to an embodiment of the invention.

FIG. 23 is a facing view of a programming matrix of the reprogrammable electric stamp according to an embodiment of the invention.

FIG. 24 is a schematic of the reprogrammable stamp according to an embodiment of the invention.

FIG. 25 is a facing view of labels according to an aspect of the present invention for use with the electronically reprogrammable stamp.

FIG. 26 is a block diagram of a telephone backup system according to an embodiment of the invention, showing the use of a wireless handset in a charger to redirect wired traffic, such as alarm calls, through the wireless infrastructure.

FIG. 27 is a facing view of a front derailleur system according to an embodiment of the present invention, showing the inclusion of a device for providing feedback from the rear derailleur to the front derailleur.

FIG. 28 is a front view of the front derailleur of FIG. 27.

### DETAILED DESCRIPTION OF EMBODIMENT(S)

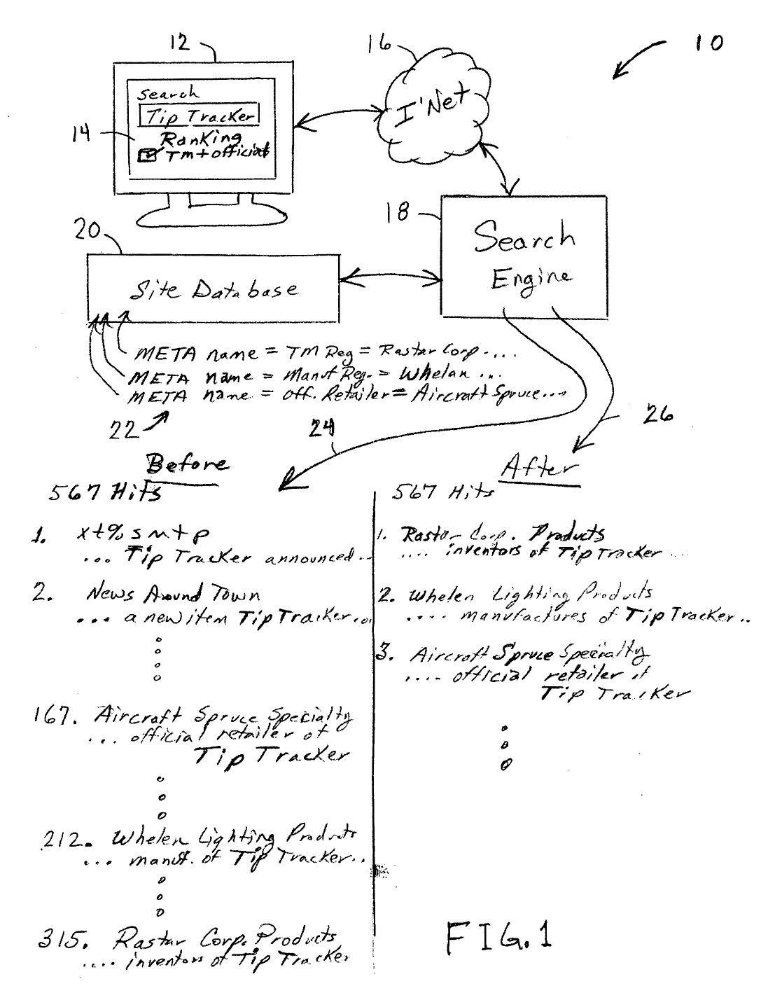

Referring more specifically to the drawings for illustrative purposes, the present invention is embodied in the method generally described in FIG. 1 to FIG. 28. The following description is presented to enable one of ordinary skill in the art to make and use the invention as provided in the context of a particular application and its requirements. Unnecessary technical details, which extend beyond the necessary information allowing a person of ordinary skill in the art to practice the invention, are preferably absent for the sake of clarity and brevity. Furthermore, it is to be understood that inventive aspects may be practiced in numerous alternative ways by one or ordinary skill without departing from the teachings of the invention. Therefore, various modifications to the preferred embodiments will be readily apparent to those skilled in the art, and the principles defined here may be applied to other embodiments. Thus the present invention is not intended to be limited to the embodiments shown, but is to be accorded the widest scope consistent with the principles and novel features disclosed herein.

### 1.1 Overview

To speed searching on the internet when entering business names, product names, slogans, or the like, so the desired entity is brought to the top of the list. The present invention provides a method by which our searches based on name key words, such as product names, business names, and so forth, can be sped up. The invention utilizes tags within the web file that direct a search to the type of “ownership” claim and an associated string describing what is “owned”. Search engines modified according to aspects of the invention incorporate features which key off of the tags to speed searching. It will be appreciated that web sites are traditionally written in a combination of HTML, XML, JAVA scripts, cgi scripts and so forth. The tags may be implemented as META tags or any other convenient tagging mechanism.

Current META tags being utilized include the following:

<META name=Description content=“description line”>

<META name=Keywords content=“keyword listing”>

<META name=Title content=“title of page”>

The present invention expands that list so that owners may indicate their rights in a name—and allow searchers to base a search on those name rights, thereby separating those who are merely linking to the site with those who have some form of right to claim that status.

One embodiment of the invention differentiates between the owner/practitioner of a trade name (trademark) and those describing, linking to, reviewing, mentioning, slamming, the given trade name. Further examples include patent owners, copyright owners, “doing business as” business names, and other such elements wherein a relationship to a name is described.

A trademark embodiment of the invention utilizes an HTML META tag within the web site, or associated pages of the web site, for listing a “Trademarked Name” or “Registered Name”. Only the owner of that trademark can legally list it under the META tag. (Infringers of the trademark in this instance could be easily found.) Multiple tags may be utilized for multiple trademarks on a given web site.

META name=Trademark registrant=“trademarked name or text”
or similarly

META name=Trademark owner=“trademarked name or text”

Use Example: Assume I want information on different models of Nike™ brand shoes. I can search for “Nike” and “shoes”, but then I'll have to wade through a pile of hits. For example a test with the above yielded 228,368 hits, with the Nike trademark owner nowhere to be found in the top few screens of web sites. It will be appreciated that every site that mentions both Nike and shoes in any context will show up. Often the searched for site may not even come up near the top of the list increasing frustration.

Search engines are then configured to search these META tags and reflect the findings in the results. The search engine may automatically attempt to match the user input, or elements thereof, with one or more types of the new META tags. The results are preferably generated in the match with the META tag first, along with an indicator, such as “Web site of Trademark owner”, or some other similar notation may be utilized.

Alternatively, the attempts to match one or more the new META tag categories may be based on user configuration or extra commands. For example checkboxes for the different category matches which indicate how the search string is to be interpreted (i.e. as a trade name, as a retailer of the trade name, as a business in Sacramento Calif., etc.) These can be in the form of a complete match given highest ranking with partial matches or similarities given lower rankings.

Examples of search use on a search site:
Configuration selection: Always put registrant matches at top of results
Check box: Search only TM META tag for relevant sites.
Checkbox: Include searching TM META tag.
Checkbox: Order search with TM META tag hits first.

Another embodiment for implementing the present invention is as a search which is configured to fond “Official” content (or another term for content from originator), as it will be appreciated that generally web site searchers are in search of “official” information when available. The unofficial sites are less likely the targets of searches but often those entities can show up earlier in searches based on their diligent use of the proper keywords, META tags and so forth. By way of example, if a person is searching for information about a shoe brand, they likely would want to check the web site of the manufacturer first. The META tags in this embodiment may all follow a similar pattern, such as follows:
<META name=Official ______=“variable field”>

In this way any number of “Official” types of sites can be created and the handling of which will preferably inherit a base class of operations. In use the user can simply mark a checkbox for giving preference to “official sites”. The determination of which types of Official sites need not be made, wherein the text may be compared against all such valid Official search tags. The text of the search string may also be checked to determine what kind of information it represents, if that form of “relationship” can be detected, such as a trademark name if the term is a fabricated name that is not representative of the language at large (i.e. standard English).

A searcher can check a box to allow all “Official” designations to be checked or a drop down list or other form of selection can be provided to allow the user to select a specific form of Official site or class of official sites. This provides a wide range of added functionality to the searcher while being easily implemented.

### 1.2 An Embodiment Described.

FIG. 1 illustrates an example embodiment 10 of the inventive system and method. A user through a computer 12, enters a search 14, herein illustrated for “Tip Tracker” and according to the invention selects to have the output ranked by Trademark holder and related official sites, using a checkbox. The search is hosted over the internet 16 by a search site having a search engine 18 which extracts hit data from previously collected information about web sites contained in a database 20.

According to the invention, additional categories of information are stored within the database exemplified as META tags 22, which state trademark relationships and other relationships with a given name or term, generally a product.

Searching the internet without the use of META tags according to the invention, leads to a set of search results 24 (shown on the left), such as represented by the list of sites. In this case although only 567 hits were generated, the desired information can only be found by paging down through 166 hits to reach a retailer site, down another 55 hits to reach the manufacturer, and another 103 hits to reach the site of the actual trademark holder. Although the number of hits is far less than the 7,930,000 hits generated for a search of “Nike”, it still requires a great deal of scrolling through and checking through content of individual sites in order to find official information.

By contrast the search results 26 (shown on the right) according to the invention are ranked with the trademark owner on the top of the list and related official sites following the list. The user is spared a huge amount of time and trouble, in particular when searching for official information relating to common trademarked names.

It will be appreciated that algorithms for searching text strings are well known in the art, for example those utilized for searching through the keyword META tags on a web site. This code can be modified for searching for these new forms of META tags, such as in response to search option settings.

It should be appreciated that a number of optional aspects of the invention are described, which can be implemented separately or in combination with other aspects of the invention without departing from the teachings of the invention. These various aspects of the invention provide a wide range of functionality that may be selected for implementation on a search engine.

### 1.3 Example META Tag Categories.

Trademark Related
META name=Official Manufacturer=“trademark name or text”
META name=Official Distributor=“trademark name or text”
META name=Official Retailer=“trademark name or text”
META name=Official Business Partner=“trademark name or text”
META name=Official Sponsor=“trademark name or text”

Patent Related
META name=Inventor, U.S. Pat. No. 4,567,321
META name=Assignee, U.S. Pat. No. 4,567,321

Copyright Related
META name=Copyrights Music/Artwork=“title and/or copyright number”

Business Name Related
META name=DBA in Sacramento, Calif.=“Johnny Plumber” [DBA by county and state]

Government Entity Related
META name=State Of=“state name” [for associated government sites]
META name=City Of=“City name” [i.e. used in conjunction with STATE tag]
META name=County Of “county name” [i.e. used with STATE tag]

Business Location Related
META name=Business Location, State=“state name and/or designation”
META name=Business Location, City=“city name and/or designation”
META name=Business Location, Address=“street or mailing address”

### 1.4 Discouraging Misuse of the META Tags.

It will be appreciated that Trademark rights in the United States and other developed countries are taken seriously, wherein web sites averring to being trademark owners can be readily prosecuted. It should therefore be easy to block entities from incorrectly putting themselves forth as the trademark owner. In this case the web site is averring to rights in the mark, wherein the excuse of inadvertent use would not be very persuasive in a courtroom.

For other than the trademark, those having rights in the name or designation may establish policies to dissuade misuse, and policies may be instituted by search engines, wherein those sites which lie about their ownership, or designation will not be listed by the site. For example, the proper owner/designee polices the net for sites incorrectly averring to rights as owner/designee. When information is submitted to search engines (preferably according to a standard policy) including information indicating actual ownership or rights, and notification of the company. Once confirmed any links to sites lying about their rights are dropped from the search engine, or they are put in a category indicating their dishonesty regarding tag use.

Other ways of providing protection for official sites extending beyond the trademark related sites. For example the invention can be implemented wherein the site associated with the trademark owner would provide an associated list of official sites for their brand, these can include sites for manufacturers, retailers, and even publications and so forth which review the items in the area of art. In this way, the validity of the “official content” would be provided by the entity in charge of the trademark, generally the manufacturer.

In another implementation the site of the trademark holder could just list web addresses for any sites officially associated with the brand while each of these individual sites would then indicate their specific relationship within a META name describing the specific relationship with the brand. In this way the trademark owner (i.e. manufacturer) would perform their own policing of what was stated by the “official” sites, and could drop web sites from their web site list if these companies were to make false statements. The list of sites posted as having some official association with the trademark is preferably checked by the search engine so that it can eliminate from the ranking any sites which contain META name tags averring to an official relationship wherein such as relationship does not exist.

### 1.5 Related META Tags—Adverse META.

If concern arises about the listing of sites that give information adverse to the trademark owner, then an averse form of META tag can be supported wherein the site indicates that it is “NOT a trademark owner” or otherwise indicates an adverse relationship. A user desiring to find critical reviews or information adverse to the trademark owner, can check a box indicating the form of adverse relationship wherein the search engine lists those sites instead of the official sites. It will be appreciated as sites could not be prosecuted for stating that they DON'T have a specific relationship—the list would rank sites containing a specific META name associated with the trademark and presumably containing a large amount of content relating to META tag matched search string, as opposed to sites which only casually mention the search string text.

An additional or alternative mechanism for ranking sites based on the search string, can be provided by the search engine establishing a specific relationship with a business information companies (or other generally well-known organization that generate a list), such as listing of Forbes™ 500, Dunn and Bradstreet listings, Thomas's Guide to Manufacturers, and so forth, wherein a list of obtained (and maintained) designating specific standings of organizations. Data for driving the search can be provided by the listing company, and the data may include such information as whether they are listed, years in business, company size, and other metrics. The listing organization can provide the list to the search engine for ranking the sites based on given metrics, and links can be provided with the results allowing the user to get additional business information about the business associated with the site, some of this information for example being made available for a fee. This can provide a revenue generating hook for the search engine.

This aspect of the invention can be supported directly from a single or multiple lists and need not require the target sight to provide a META name with their official designation in relation to the business site.

Along the lines of the above the trademark owner could be located by the search engine through a list provided by an official TM database, made available for use by the search engine. Another method of speeding the search is to have trademark owners put a link into an official USPTO trademark listing, wherein the word mark is listed with the web site. As this may draw inordinate traffic to the USPTO site, it would be more valuable for the search engines to periodically receive updates from the USPTO, or other entities wanting this list. Wherein searches can be based on this list, or use information from the list to enhance the search. In this way the “ownership” information is readily maintained and false entries are avoided.

1.6 Ranking Associated with Content Specificity.

Ranking of search results for the invention described may be performed by alternative methods. Ranking in response to specificity of results. For example a site dedicated to, for example “mountaineering” should be ranked higher than one which is dedicated to “mountaineering”, “traveling”, “sports”, “bike riding” and so forth. These distinctions are preferably made based on the information from the META name tags, although the decision can also be made based on the content of the site, wherein sites with greater specificity are accorded greater weight. The amount of specificity can be in some relation to the size of the target site instead or simply a count of matches, wherein the percentage of the site dealing with the topic is considered and not just that appearance of scattered references throughout a huge site. The specificity relationship can be utilized separately, or more preferably in combination with the other relationships, such as official sites and so forth.

It is generally presumed that greater specificity increases the chance of the user receiving sufficient information to meet their search desires, while definitely being easier to determine the fit since less content need be perused.

### 1.7 “Inverse” Ranking of “Link” Sites.

Selective downgrading the ranking of “link” type sites. Many sites provide links to specific forms of content. However, during a search the user may or may not want multiple sets of link sites, as they may want the actual content instead. The user is preferably provided with selections that allow pushing “link sites” down or up in the rankings depending on their need.

These link sites can be readily discerned by the percentage of links provided within their level of content. Discerning of these sites allows the user control over whether they are seeking to go through link sites or directly to a desired entity.

Sites utilizing “deceptive” practices can be ranked lower than other sites. The rankings can include information from consumer protection organizations as a user preference, or based on the textual approaches of the site.

Sites generating “spam” can be ranked lower than other sites, such as based on actual metrics obtained from the search engine, or from organizations that monitor spam or otherwise have metrics relating to these web sites.

The present invention describes a number of embodiments and variations for speeding the search for “official” forms of content on the internet or other searchable network. It will be appreciated that the aspects of the invention may be implemented in a number of alternative ways, with different forms of tags and ways to gather information on the sites being ranked, without departing from the teachings of the present invention.

### 1.8 Embodiment of Search User Interface.

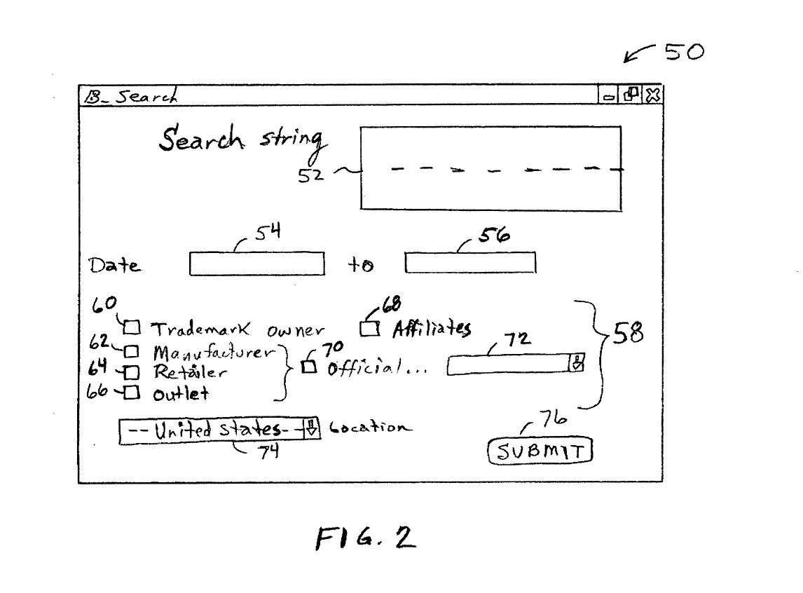

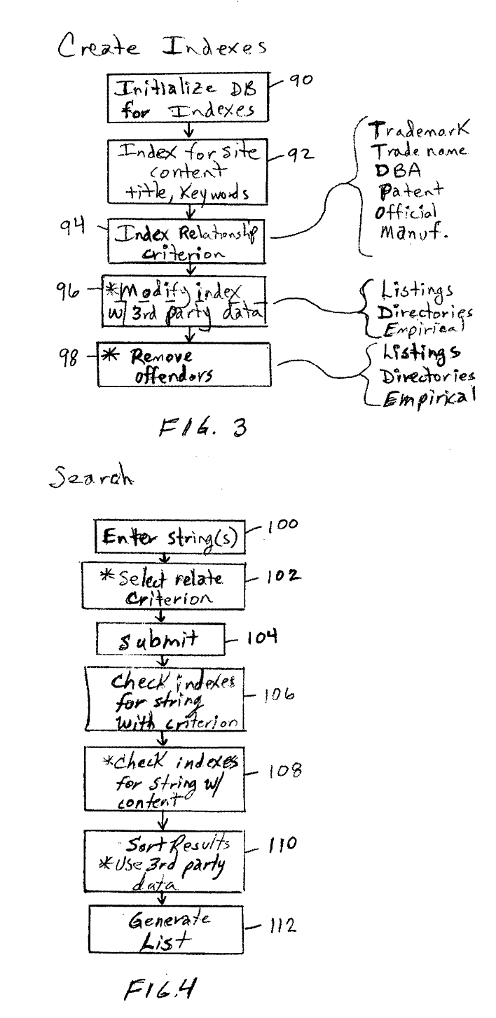

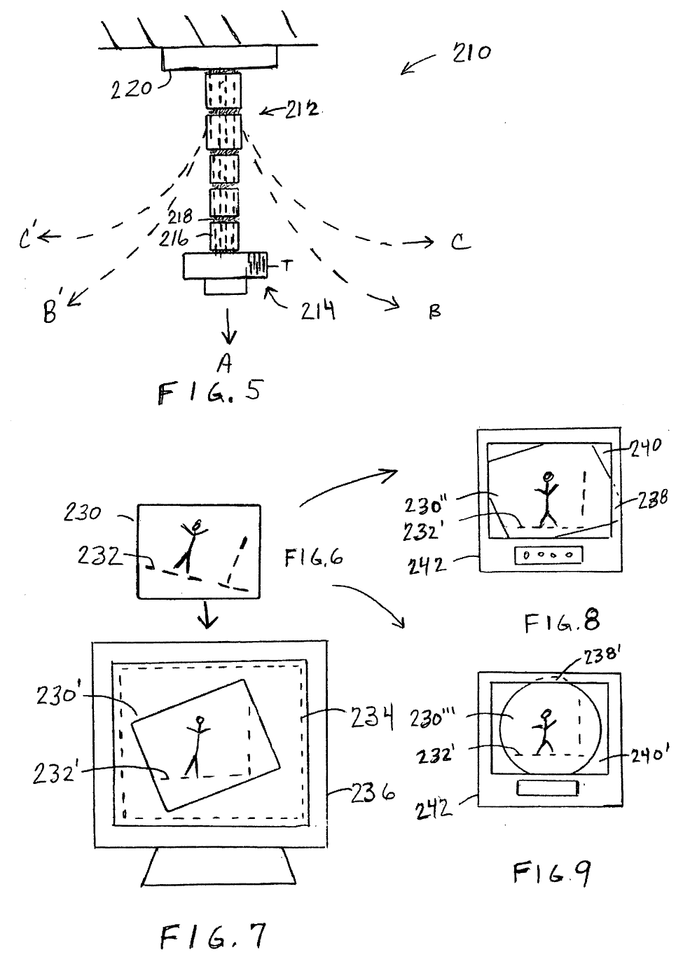

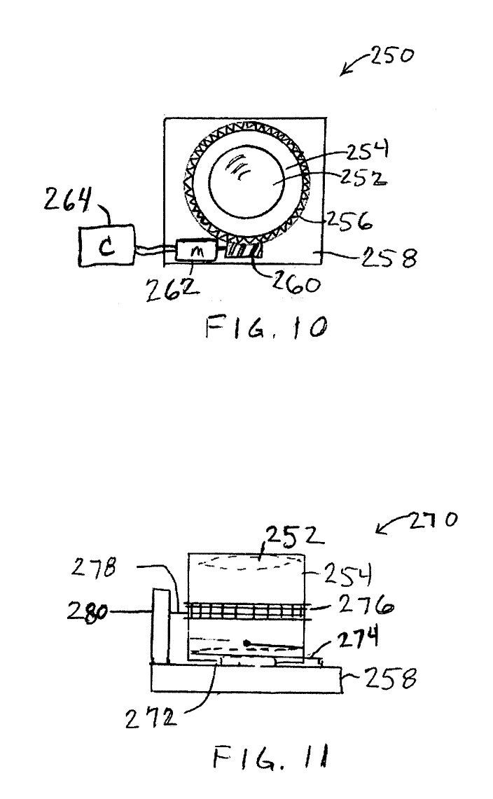

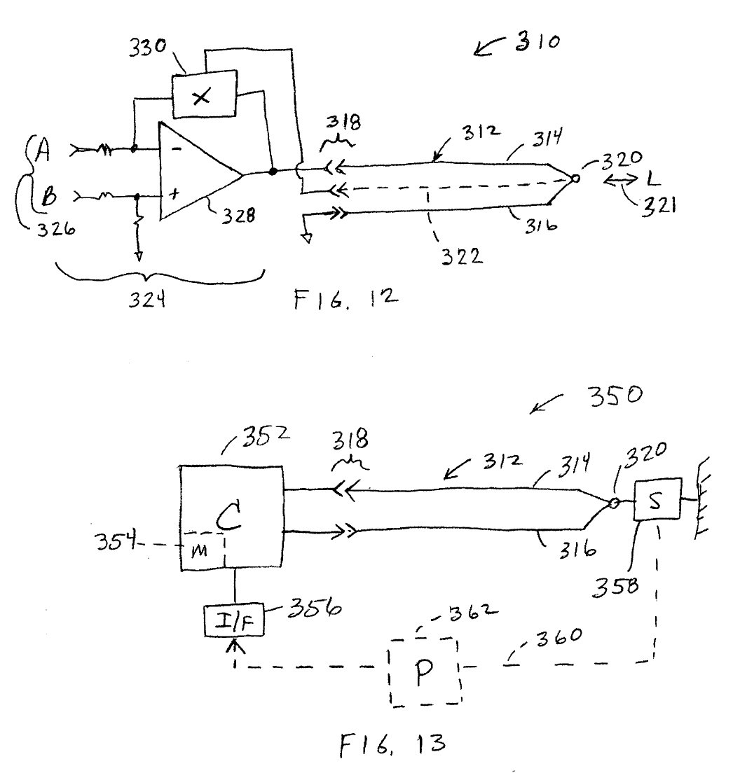

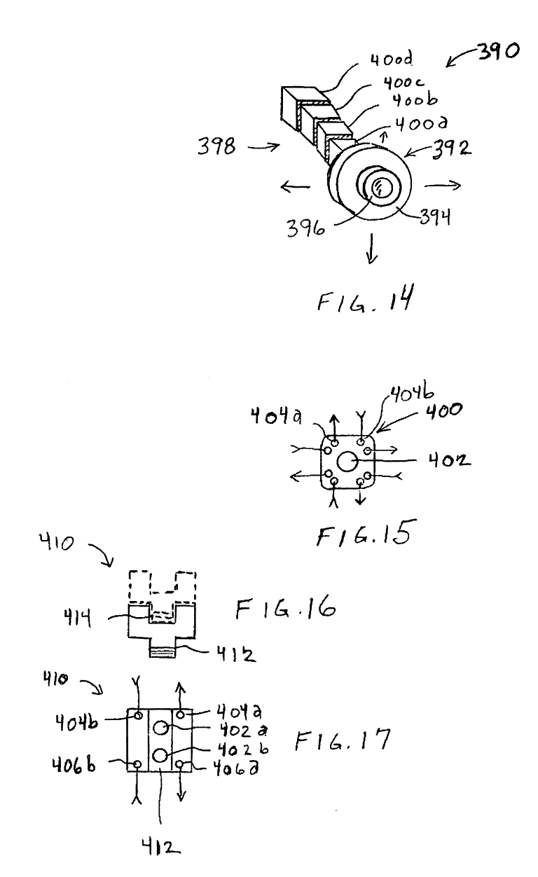

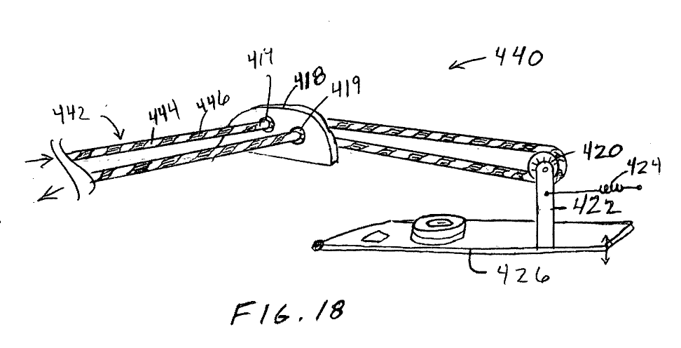

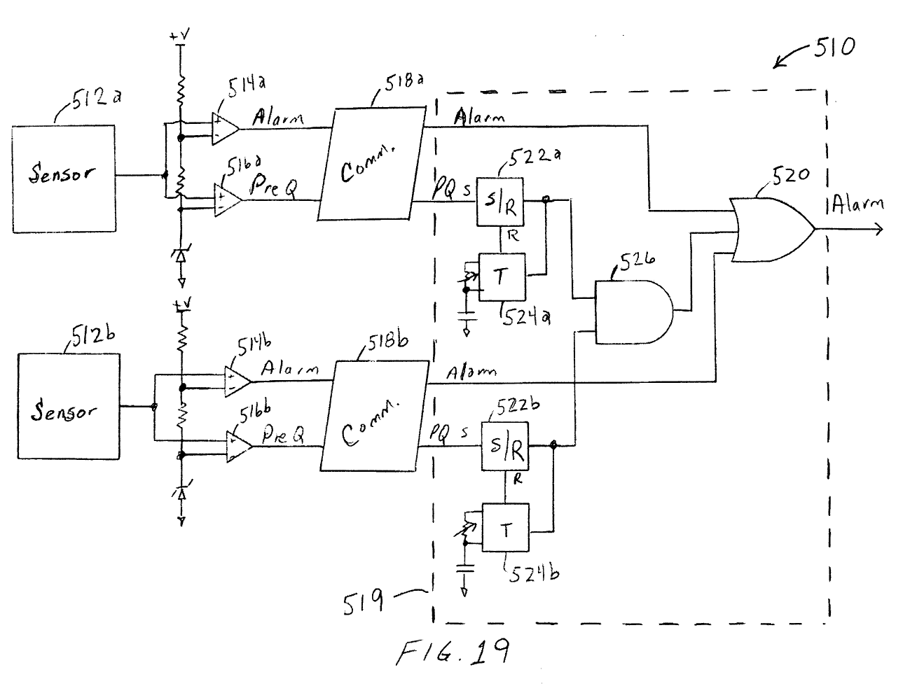

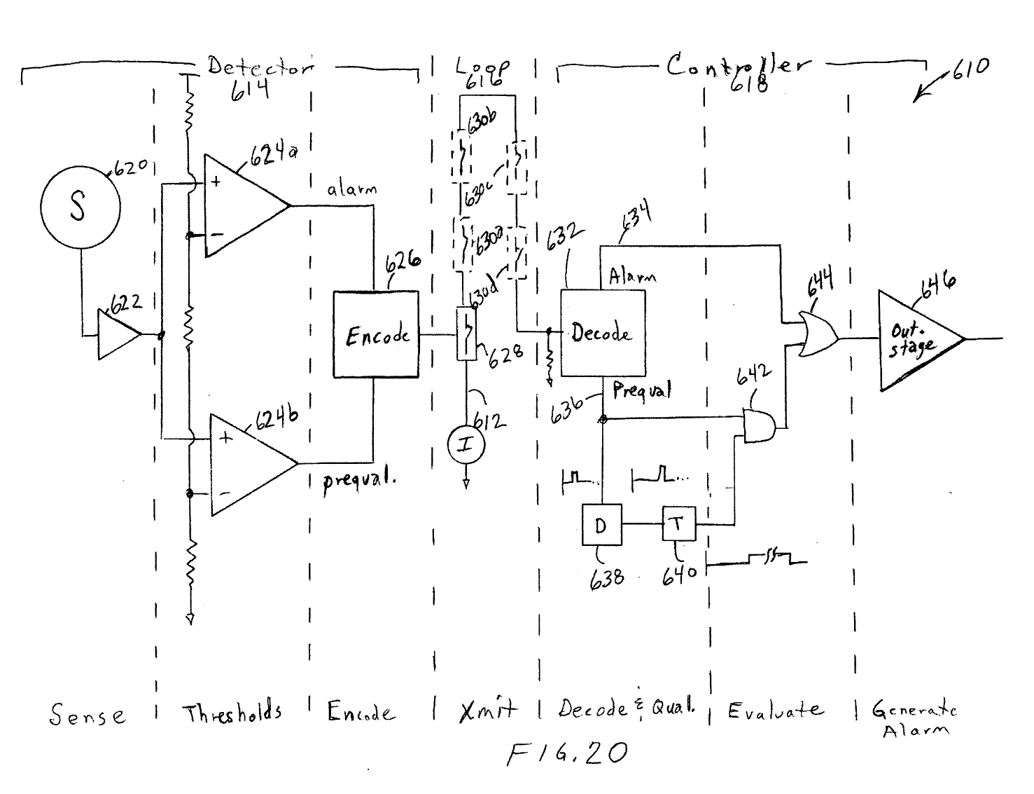

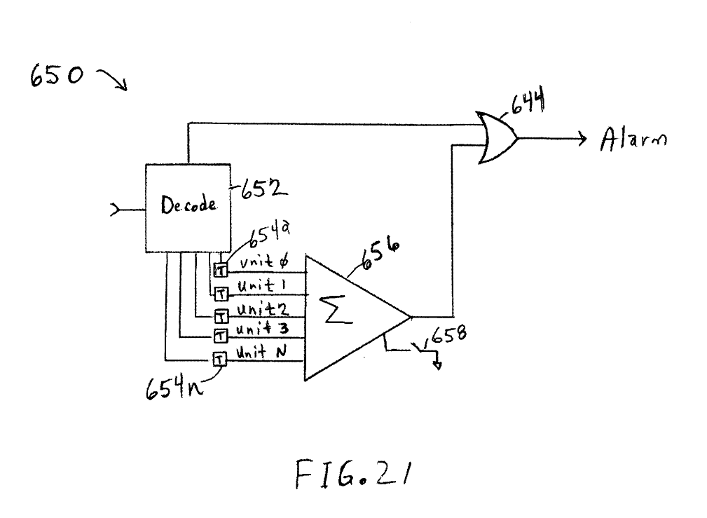

FIG. 2 illustrates an example embodiment 50 of a search engine user interface which is configured for performing the relationship functions of the present invention. It should be recognized that the aspects of the present invention can be incorporated with any other desired search engine functionality, such as combined with any conventional aspects of a search. In this example the user enters the search string in field 52, which can be any type of search strings, boolean, multiple field search strings, and so forth. It should be appreciated that a search field can be provided for a conventional text and content search with another field provided for stipulating relationship information. The dashed line through the field representing that a variety of search text strings can be entered here. Other conventional elements may be user selected as well, such as date range 54, 56, and so forth. By way of example relational selections 58 can be selected according to the present embodiment with check fields for trademark 60, manufacturer 62, retailer 64, outlet 66, and affiliates 68. The user can select whether these entities are to be verified as “official” status entities by checkbox 70, such as verified from third party data. Other forms of “official” selections can be preferably selected, such as by a pull-down box 72. Location specific information 74 can be utilized in conjunction with one or more of these relationship specifiers, in particular for retailers and outlets, which may be visited by the patron. A submit button 76 is activated to submit the parameters to execute the search.

It should be appreciated that an embodiment can also be implemented in which the relational elements (i.e. 58 in FIG. 2) may be automatically searched. For example, wherein the relational elements which are found in web sites through the specialized META tag searches, or in data supplied by third parties regarding the relationships, can be automatically placed at the top of the search results along with information about the META tag that was matched for that entry. In this way the searcher can be provided the additional relational information that they can decide if they want to use. Conventional search sites often already provide some hits at the top of the list for paid site, wherein the hits found in response to the relational matches can be listed in another area, such as under the paid sites prior to the listing of sites which are ordered strictly based on conventional content.

FIG. 3 and FIG. 4 illustrate examples of an embodiment of the method, with FIG. 3 depictings steps performed when indexing web sites (i.e. spidering) while FIG. 4 depicts steps during the use of the search engine.

In block 90 the search engine database is initialized for the indexes. When first adding new fields within a database the entries are added and initialized to default values. The search engine software would already have been modified for utilizing the additional data fields for the relation functions (i.e. ownership or official relationship). The indexing process commences at block 92 on sites on the world wide web, it will be appreciated that this is an interactive process, although processing is only shown for a single web site in this example. A site is indexed conventionally for content, title, keywords and so forth.

In block 94 the information in the site is compared to find relationship criterion implemented for this search engine, which are indexed into the database. The web sites can be checked for META tags supported in the system, the results found can be checked against third party data, such as to prevent false entries. Furthermore, the web site itself can be checked against third party data to determine relational aspects of the site (i.e. owning a specific Trademark, official outlet for company XYZ, listed on the Forbes 500, located within a specific region, etc.) By way of example and not limitation, the criterion are depicted as being Trademark, Trade Name, Doing Business As (DBA), Patent, Official sites, Manufacturer. It will be appreciated that different search sites may elect to support different sets of relationship aspects depending on what they expect will best fulfill user desires. For example similar to the way that different search engines currently support different forms of boolean logic.

In optional block 96 the indexing process is modified with third party data (i.e. listings, directories), which optionally could be data purchased by the search engine host, created by the search engine host itself, or even created during the index creation process (i.e. empirical) based on content heuristics targeted at the particular criterion.

In another optional block 98 the sites can be checked against a list of “offenders”, which may be spam-generating sites, porno sites, or other forms of despicable sites which are not being spidered for access by the search engine. These offensive sites can be either dropped totally, or their ranking scores dropped, so that in a list they would show up lower on the list. It will be appreciated that this is not the same as a search filter, because a search filter is applied during a search after the web sites are indexed, in this feature data is extracted during indexing to alter how the sites are to be ranked. The rankings can be based on third party information provided (i.e. listings, directories), or based on empirical data collected from the site itself. A simple example of checking the site during indexing, is to check for the extent of offensive words and graphics to ascertain what category the site fits into.

Once sites are indexed into the search engine database, users can access the search engine and the additional relational data available can greatly aid user searches.

FIG. 4 illustrates utilization of the search engine wherein the user enters a search string 100, optionally selects relationship criterion (i.e. ownership, etc.) 102, and submits 104 the information to start the search. It will be appreciated that the search engine may be configured to search for all or select criterion automatically, which can augment o completely replace the need for the user to select criterion. It is contemplated that if a large number of relationship criterion are to be supported then the user should select which of them are to be searched against. However, if a smaller number of criterion are supported (either by the web community or search engine) then the relationship searching would more likely be automatic, or semi-automatic.

It should be appreciated that the user may establish a set of criterion for how they like to perform searching, which would modulate the parameters of the search and what information is being asked of the user. These preferences may be established and associated with a user login process, wherein the user need not specify their preferences with each new search. In block 106 the search is performed against the indexed site database and matches with the relationship elements are found. Optionally, the conventional search aspects can be performed at block 108, to select additional sites or to further qualify the relationship criterion, aiding in the ranking thereof.

In block 110 the results can be optionally processed using additional information such as from third parties, which can aid in verifying the ownership or official nature of sites, or useful in providing a further ranking of sites. Finally, the ranking of sites is listed for the user at block 112, preferably with any relationship criterion being printed above any sites which were selected based on those criterion, therein showing the user how the sites were selected. A number of different ways can be utilized to represent how the sites were chosen and ranked. One novel method is to provide a graphic background (preferably in various colors) which depicts in a map or graphic form the contributions of the various relationship criterion, search string text, and preference criterion. For example the background can appear as a topological map, legends may be optionally displayed in text about the edges of the search listing for a site. The map may also be shown as a graphic separate from the search listing text, such as to one side. The map may also be in the form of a columnar graphic, wherein each major selection criterion is shown by a column and text (i.e. number from 0-9) or graphics (i.e. colored blocks or bars, icons, etc.) can be used to represent the extent that each criterion led to the ranking.

It should be appreciated that the teachings of the present invention can be embodied in a number of different implementations without departing from the teachings herein.

### 2 Flexing Motion Stage Driven by Muscle Wire.

### 2.1 References.

The following are incorporated herein by reference:

regular utility patent application docket “KeyboardRAST070103” Ser. No. 10/612,777 filed Jul. 1, 2003 and related provisional patent application 60/394,160 filed Jul. 1, 2002;

regular utility patent application docket “Display_RAST092303” application Ser. No. 10/670,432 filed Sep. 23, 2003, and related provisional patent application No. 60/413,199 filed Sep. 23, 2002;

regular utility patent application docket “TipTracker_{—}02” application Ser. No. 10/245,909 filed Sep. 15, 2003, and provisional application Ser. No. 60/413,199 filed Sep. 15, 2002.

### 2.2 Motion Stage Summary

The motion stages previously described by the inventor provide a number of advantages over conventional stages. The present invention extends those benefits with additional aspects that are suited for additional applications.

### 2.3 Articulated Arm.

One embodiment described in the prior applications was an articulated arm comprising a number of segments, such as compliant beads, strung with muscle wire whose length is modulated to alter the positioning of the articulated arm. One use example being that for changing the direction that a camera is oriented, although this articulated member may be utilized in a number of additional applications. The articulated arm can be manufactured at low cost without motors and gears or other moving parts requiring periodic maintenance. The muscle wire position controller can be readily controlled without the need of stepper motors and step counter, or DC motors and complex position feedback systems. The present invention can be directly controlled in response to output current levels, such as directed from the pulse-width modulated output of a microcontroller or similar.

FIG. 5 illustrates an example 210 of an articulated arm 212 of the invention to which a camera 214 is mounted. The articulated arm 212 comprises a series of segments 216 which are compliant themselves, or between which are disposed compliant materials 218 as shown. Flexible wiring (i.e. conventional cables using stranded wires) extends through a passageway in the segments from a base 220 which preferably contains the control electronics. Optionally conductive elements may be incorporated within the segments themselves to provide electrical connection through the articulated element to a payload at the tip, such as the camera shown by way of example.

Shape memory wiring, commonly referred to as muscle wire, are retained in additional passageways preferably near the periphery of segments 216 wherein the selected contraction (or relaxation) of the muscle wires can induce motion in a desired direction. The muscle wires extend through the segments 216 down into base 220 where the ends of the muscle wire are physically retained and electrically terminated. Preferably electrical drivers within base 220 connect to the muscle wire for driving current through the wiring to contract sections of the wiring to direct the arm in an intended direction.

Articulated arm 212 extends down from mounting 216 and can be flexed to direct the camera in any desired direction. The direction may be modulated toward any polar angle and may be tilted up to an extent controlled by the amount of flex within the segments and the relative contraction of the muscle wire in the given direction (contraction on muscle wire on a first side with relaxation on the muscle wire on an opposing second side). Tile angle is shown changing from position A through position B and up to position C which is substantially horizontal. It will be appreciated that the arm can be implemented to even curl back sufficiently to allow the camera to reach the vertical, however, in many applications this would only achieve a close-up view of the ceiling.

In many applications, such as when using the stage over a small range of motion, the video feed from the camera may be utilized as received. Other applications, however, can benefit by modifying the orientation of the images from the camera so that they maintain a consistent orientation. It will be appreciated that the feed from the camera is directed to a display or is recorded for later display. Image portions collected from a first side of the camera being displayed at the top of the display screen, with the portions from the opposing side displayed at the bottom of the display screen. It will be appreciated that we are accustomed to seeing images on the display screen in their proper orientation.

Presuming for a moment that the top T of the camera is oriented toward position B, wherein proper orientation is maintained as the camera is moved up through position B and up to position C. However, it will be recognized, that in moving from position B to B′ or from C to C′ that the raw image would become inverted. Furthermore, images collected from side angles would be presented sideways due to the relative camera position.

The present invention provides is configured to correct the orientation problem of the camera to the scene by performing (1) electronic reorientation, (2) camera rotation, or a combination of the two.

### 2.4 Electronic Image Reorientation.

Electronic reorientation according to the present aspect of the invention performs a rotation of at least the center of the screen and optional cropping to match that of the display. The amount of screen rotation being preferably determined in response to the positioning of the camera. The camera position can be estimated by the control circuits modulating the muscle wire currents, since it is attempting to drive the camera to a programmed position. Alternatively, the position may be measured, such as by an tilt sensor, accelerometer, other position sensitive sensor, or based on the signals levels being used to drive the position of the camera. Furthermore, the position can be extracted from the image, such as utilizing neural programming or heuristics which determine position based on physics (i.e. center of mass of an individual must be over their feet), the geometries of the room where the camera is located and so forth.

By way of the example above, the screen images are rotated 180° prior to display in response to positioning at B′. It will be appreciated that the output of the camera is traditionally formatted as a rectangle (i.e. Low resolution 176×144 pixels, 352×288 pixels, VGA 640×480 pixels, EIA or NTSC format with 512×492) which can not be rotated when shown full size on a screen. Aside from utilizing a camera having a circular image output, the image output can be rotated in real time for viewing in a number of alternative ways.

2.4.1 Unclipped Image Rotation.

Rotation of images (or images in a video stream) of a first resolution on a screen allowing a higher resolution. For example, images, a stream of images, or a full-motion video stream having a resolution of 352×288 can be shown in any desired rotation on a VGA display having 640×480 pixels. This mode allows all the captured image data to be displayed in the proper viewing orientation. It will be appreciated that the display resolution may be modulated, such as increased to allow utilizing this mode with higher resolution images, for example upping screen resolution to EGA when rotating a VGA image.

FIG. 6 illustrates an image 230 captured with the camera at an off angle orientation 232, wherein the image (frames or video) is rotated into an image 230′ in FIG. 7 within a larger resolution background 234 and shown displayed on a display 236 having more resolution than the camera. It will be seen that orientation 232 has been corrected 232′ with the proper conventional vertical viewer orientation.

2.4.2 Clipped Image Rotation.

Clipping rotated images to fit the screen size. The images are clipped to fit the desired screen size. For example the output of a VGA camera rotated ninety degrees for display on a VGA screen. The raw output of 640×480 is rotated ninety degrees and clipped to 480×480 for display on the VGA screen.

FIG. 8 depicts the above situation wherein the image 230 of FIG. 6 is rotated and clipped forming image 230″ with proper orientation 232′. It will be noted that portions of the screen image are clipped 238, while a fake background 240 is inserted in other portions (i.e. such as a fixed color or pattern preferably distinguishable from the foreground image) of display 242.

2.4.3 Circular Clipped Image Rotation.

Displaying a circular image. If the camera output is regularly subject to capturing images from different angles, then it can be less disruptive to the viewer to clip the images to a circular format prior to display. In this way the image appears the same size no matter how it is rotated on the display.

FIG. 9 depicts the above situation wherein the image 230 of FIG. 6 is rotated and only the circular center section of the image 230′″ (clipping and rotation may be performed in any desired order) is sent for display in the proper orientation 232′ on display 242. The circular area is shown being partially clipped in portions 238′ to optimize viewing the remainder of the image, while larger portions of the display 240′ do not contain the image and are filled with a convenient background.

In this mode the imaging system may be configured to direct the center of camera focus to where action is occurring, for example a person enters camera focus and moves to a door where they begin “working on” the lock. A modification of this technique utilizes heuristics to determine if action is spanning past the extent of the circle wherein it can stop clipping the images to the circular pattern and utilize mode A above for displaying the images.

2.4.4 Implementation.

The electronic techniques for rotating images, clipping images and the like are not described herein, as they are well known in the art and utilized within a range of products including image processing software (i.e. Photo-paint™ by Corel Incorporated®), video production software, and the like. The image transformations can be performed in a computer system, such as a personal computer operating as a server, that receives the image stream. The video stream may be processed at the camera, such as on a computer processor, DSP, or the like that performs the image transformations in real time before transmitting the images or image stream. Similarly, processing can be similarly performed at an intermediate device.

### 2.5 Camera Rotation.

The camera may also be rotated to maintain the desired orientation, or rotated in combination with image transformation to provide a properly oriented output. It will be appreciated that a camera rotatable through 360° has no need of image processing for rotating the image to the proper alignment, although it may be performed while waiting for camera rotation or to accommodate other situations. However, on a camera which is rotatable through 180° image transformation may be utilized for rotating the image a fixed 180° wherein a full 360° of rotation is thereby provided. Similarly, a camera which is rotatable through 90° can be utilized with transformation software that allows rotation of 90°, 180°, and 270°, wherein a full 360° span of image orientations can be properly reoriented.

### 2.6 Motor or Piezoelectric Panning Drive.

Rotation of the camera may be accomplished by including a conventional rotation stage within the camera housing at the end of the articulated arm. For example a rotatable housing with external gear teeth may be driven by a worm gear.

FIG. 10 illustrates an example 250 of a camera with lens 252 retained in lens housing 254 having mechanical means of rotation. The rotation in this example created in response to gearing 256 rotatable on camera housing 258 operable in combination with worm gear 260 which engages gearing 256 to drive camera position in response to the movement of motor 262 as driven by a controller 264. Although not shown, camera 250 is preferably connected to an articulated arm 212 for changing the direction of focus. It should also be appreciated that the rotation may be limited to the imaging device, such as CCD or CMOS imager, whereas the lens may remain stationary.

The motor and worm gear above may be replaced with a piezoelectric actuator engaging very small teeth gearing on the housing to move the housing in a first of second direction. Rotating piezoelectric actuators have recently become available which could be utilized or their technology utilized for producing the desired rotation.

### 2.7 Muscle Wire Panning.

Muscle wire may also be utilized to rotate the stage with fewer moving parts and with less generation of electrical and acoustic noise. One mode of this is by utilizing muscle wire to apply rotation in a first direction against a biasing force acting in an opposing direction.

FIG. 11 illustrates by way of example a rotatable imager element 270 on base 258. The lens housing 254 is shown configured with an axial rotating bearing 272 on base 258. A biasing means, depicted as a coiled spring 274 is shown wrapping about a portion of lens housing 254 to apply a bias force in a first rotational direction. A portion of the exterior housing 254 is configured with ribs, rollers, or other means 276 that allows over wrapped muscle wire to slip in response to changes in length. A section of muscle wire 278 (preferably a looped back length so current can be applied from one end) connects from a fixed member 280 and wraps about the ribbed portion 276 of the lens housing to a end fixed on the housing.

When no current passes through the muscle wire, it extends to a rest length, wherein the bias force generated by spring 274 rotates lens housing 254 to a rest position, preferably against a stop so that the rest position remains constant over time. Upon application of sufficient current to the muscle wire 278, such as using pulse-width modulated (PWM) output from a microcontroller, it contracts generating a rotational force in opposition to the bias force of the spring and lens housing 254 rotates accordingly. It will be appreciated that the muscle wire must be somewhat free to slide over the exterior of the housing during contraction or expansion, so that the change in length is applied to a rotation.

For example assume the muscle wire makes ten circumferential wraps about lens housing 254 in a relaxed mode. Upon the system generating sufficient current in the muscle wire to create a 5% contraction (presently about the maximum contraction achievable with muscle wire is less than about 10%), the lens housing must rotate one half turn (180°) as the circumference remains the same while the length of the wrappings has changed. The technique can be utilized for rotating the stage any desired amount, with more wrappings for more rotation and less wrapping for less rotation. This design has a fixed rest position deviation from which current is required for moving the stage.

Alternatively, a push-pull muscle wire arrangement may be utilized wherein a center position is achieved by equally contracting opposing sections of the wire wound in different directions about the rotating portion. For example the biasing device, spring 274 of FIG. 11 may be replaced with another section of muscle wire wrapped about lens housing 254 in an opposing direction. End rotational motion positions are achieved by fully relaxing one length while substantially fully contracting the opposing portion.

It should be appreciated that the use of polymer muscle can provide either relaxation or contraction of the muscle wire in response to the application of drive current. It should also be appreciated that the muscle wire rotation mechanism described above may be utilized at or near the camera end of the camera position control, at the base of the articulated arm or less preferably at intermediate positions along the arm.

### 2.8 Controlling Muscle Wire Drive Power.

One of the problems with driving muscle wire is that the material is sensitive to the drive current while being subject to often substantial batch variation. Although these problems are becoming less pronounced, it can be difficult in some situations to properly drive the material toward optimum performance without tuning the circuit for each specific section of muscle wire being utilized. The drive sensitivity is particular evident in Nitinol, as newer polymeric muscle wires are expected to exhibit less sensitivity to drive variations.

This aspect of the invention describes mechanisms for overcoming the drive vagueries in certain applications.

FIG. 12 is a muscle wire and drive circuit embodiment 310. A length of muscle wire is being drive, herein depicted with a loop having first portion 314 and second portion 316 extending from a connector 318 at a proximal end out to a mechanical connection 320 at a distal end. Contraction and relaxation of muscle wire 312 in response to a drive signal cause movement 321 of a load L.

In this embodiment a sense means is coupled to muscle wire 312 to provide feedback on the stretching of the muscle wire for modulating the power output of the drive circuit. By way of example this sense means comprises a sense wire 322, shown coupled between connector 318 at the proximal end and connection 320 at the distal end. The muscle wire is shown being driven by a drive circuit 324 in response to input signals (A & B) 326. In this example, the drive circuit is exemplified as a differential amplifier 328 with a feedback block 330 which is responsive to the condition of sense wire 322, such as in particular the resistance of wire 322 which changes in response to its length.

Without sense wire 322 the drive circuit applied current, or voltage, to the muscle wire in response to values established for a nominal muscle wire. If the muscle wire, however, strays from the nominal muscle wire then it is subject to be incorrently driven or damaged. The addition of the sense wire, allows the drive circuit to alter output drive in response to the characteristics exhibited by the muscle wire under a drive current or voltage. Feedback block 330 registers the changes in the characteristics of sense wire 322 to modify the drive output therein normalizing circuit output over a wide range of muscle wire fibers. Sense wire can provide an output, such as resistive, inductive, capacitive, optically (i.e. for optical fiber driven by optical transmitter and sensed by optical receiver), electric field changes, radio-frequency and so forth. The use of a resistive sense means being very easy to implement with a linear drive circuit as shown, although various other forms of drive circuits are contemplated.

FIG. 13 depicts another example embodiment 350 of muscle wire output correction. Muscle wire loop 312 has first and second halves 314, 316, although like FIG. 12 it can be implemented as a single muscle wire lead (non-loop) insofar as a connection is established at both end for applying a current through the muscle wire. In this embodiment a digital circuit, depicted by way of example as a microcontroller 352 with a section of non-volatile memory 354, and interface 356, provides the muscle wire drive output, such as according to a pulse-width modulated output. An optional power driver circuit can be incorporated (not shown) which is controlled by the digital circuit (i.e. microcontroller) if additional current or linear control is necessary.

Muscle wire control is normalized in this embodiment by registering muscle wire activity by sensor 358 during a calibration process. The system being preferably decoupled from sensor 358 after calibration. Data from sensor 358 being routed 360 to interface 356, optionally processed on the way by a processing element 362 (i.e. test system) over a range of muscle wire outputs. Correction factors are stored within non-volatile memory 354 of controller 356 which corrects the current or voltage output, or more preferably the pulse width of the PWM output over the operational range of the muscle wire. It will be appreciated that this provides a low cost approach for assuring that the operation of each system is normalized to the characteristics of the muscle wire being utilized.

### 2.9 Limiting Articulation Directions.

The articulated arm of the present invention may be constructed to eliminate, or reduce, inadvertent rotation caused by slight rotations occurring between segments of the segmented arm.

FIG. 14 and FIG. 15 illustrates an embodiment of a controllable view camera system 390 having an imager 392 (still, frame sequencing, video, etc.) comprising base housing 394 with lens assembly 396 extending therefrom. Articulated arm 398 comprises a series of segments 400a-400d, shown having a square or rectangular cross section. Movement is slightly encouraged along the four directions perpendicular to the flat sides of the segments. FIG. 15 illustrates a single segment 400 with a center aperture 402 for routing electrical wiring and toward otherwise reducing material needs. Apertures 404a, 404b about the periphery are preferably arranged in pairs on each side of the segment. The muscle wires are routed up to an end and back down to the base and when current is passed through one set of wires more than others tightens the wire compressing the segments on that side creating an angular displacement along the length of the articulated arm resulting in a camera angle change.

FIG. 16 and FIG. 17 illustrates an articulated arm 410 shown in a top view and facing view respectively. A vertical ridge 412 is shown having rounded corners and a recessed slotted rear portion 414 into which vertical ridge 412 from a prior section can be fit into. Dual passageways 402a, 402b are shown through which wiring may be passed for providing control and image feed. It will be appreciated that this arrangement is suited for curving while retained in a single plane, thereby providing a tilt mechanism. Only two muscle wire loops are shown one passing through apertures 404a, 404b to pull the segments in an upward direction, and a muscle wire loop 406a, 406b for pulling the segments in a downward direction. The ridge interfacing with the slots prevents sideward movement while allowing curvature in the single plane. This may be utilized in applications requiring only tilt changes or utilized in combination with a pan mechanism, for example, as described previously incorporated in the base wherein a full range of directions can be achieved.

### 2.10 Polymer Muscle Wire Applications.

Alternatively utilize polymer-based “muscle” fibers as these provide up to 50× the contraction of metallic muscle wire at lower weight, and they relax back to a state that is closer to the initial state before stretching, (less force required to elongate the fiber after power is removed).

In the present aspect of the invention the polymer muscle wire is encased on an abrasion resistant sheath, such as formed in a spiral pattern, conformal netting, or other compliant shape that can conform to the exterior of the muscle wire and that does not substantially limit the expansion and contraction of the muscle wire fiber. The case can be formed from UHMWPE ultra-high molecular weight polyethylene, or other material to overcome the drawbacks with the polymer, such as sticking to surfaces, or being abraded on contact with surfaces. For example the UHMWPE provides an abrasion resistant surface allowing the force of the muscle wire to be redirected about one or more points of contact.

FIG. 18 depicts an embodiment 440 of a polymeric form of muscle wire, herein referred to as a muscle polymer 442 with core 444 and sheath 446 passing through apertures 449 in a force redirection member 448 and connected around a pulley 420 connected to an actuator output arm 422. Current flow through the loop of muscle polymer causes pulley 420 to be pulled toward or away from redirection member 448 as the length of the muscle polymer changes and is kept under tension by bias device 424, such as a spring. This is shown as an example of using a muscle polymer.

To prevent the polymeric shape memory material from chaffing when directed through redirection member 418, core 444 comprising one or more fibers of polymers that change length in response to current flow, is covered with a sheath 446. Sheath 446 is preferably stretchably compliant, such as formed by a helical pattern (or netting, and so forth) of thin UHMWPE, or similar low friction abrasion resistant materials. The sheath can be employed to reduce the friction between the fiber and other objects while reducing abrasion on the fiber.

It will be appreciated that multiple sheath layers may be utilized to cover the muscle polymer while retaining the ability to stretch and shrink. The sheath is particularly important when redirecting the force of the muscle polymer, such as depicted in this figure, where a redirection member 418 is shown with two apertures 419 through which the muscle polymer passes, the force applied being redirected and a resultant force applied between the outer diameter of muscle polymer 442 and the interior of aperture 419. These forms of force redirection on a sheathed muscle wire may be utilized in a number of applications.

Sheath 446 may optionally be formed from, or include, one or more conductive material or layers for altering current flow patterns. In one example voltage can be applied between conductive sheathes wrapped on opposite sides of the muscle wire, wherein current passes through the core to change its shape. This mode can be utilized when the conductivity of the muscle polymer is low, or if transverse current flow is warranted to suit a specific application.

It should be appreciated that traditional muscle wires formed from metallic alloys may be covered with a friction reducing sheath according to the present invention, that does not prevent expansion and contraction of the muscle wire, without departing from the teachings of the present invention.

### 2.11 Specialized Applications.

Although the present embodiments of articulator may be utilized to replace convention pan and tilt mechanisms, they provide aspects which are especially beneficial in a number of areas. The following being provided by example and not limitation.

The articulators according to the invention can be configured with a long articulated arm that can be curved back upon itself allowing the unit to inspect itself and surrounding area. Conventional pan-tilt mechanisms are limited to a limited tilt angle and the camera remains generally fixed in the center.

The articulators according to the invention can be electronically manipulated (steered) to go through passageways, or around corners and so forth. For example the device can be utilized and flex around corners to provide a view for a military combatant without the need to expose themselves to attack.

The muscle wires and polymers according to the invention can also be utilized for modulating the direction of intrusion sensors so that the dead-spots within the sensing areas can be changed with respect to time. The swept ranges are thereby less prone to intrusion. The muscle wire can also be connected within the detector housing to change the angle of board 426 in FIG. 18, without the need for motors and gearing.

### 2.12 Embodiment Using Other Forms of Muscle Wire.

The embodiments of the invention can utilize muscle wires which contract in response to the application of drive current, or alternatively muscle wires, such as certain polymeric muscle wires, which expand instead of contract in response to the application of electrical current. This form of muscle wire may be utilized with the motion stage described previously by inventor, have a sheath as described previously, be utilized as a control device for a small model aircraft, or in any other described application with the caveat that the contracted and stretched phases are reversed in relation to the application of current.

The above description considers the use of muscle wire fibers which shrink in response to the application of current, however a recently demonstrated polymeric muscle wire fiber actually stretches in response to the application of a sufficient electrical current. It should be appreciated that the stretching muscle wire fiber may be utilized in the same general embodiments as the shrinking muscle wire fiber, however, its contracted and expanded phases are simply reversed in relation to the application of current. For example in the above example of the “beaded” flexing motion stage, the use of this new polymeric muscle wire fiber would mean the device in a default state would be scrunched up in a straight line with all fibers in tension. Application of current to muscle fibers on any side of the unit would result in deflecting the motion stage toward that side, applying current to a combination of two sides allows a deflection between those sides, while applying current to all muscle wires would allow the unit to go limp, wherein gravity or other applicable forces (or positioning just prior to applying current to all muscle wires) could dictate the direction of flexure.

The above figures can be fitted with the current induced stretching muscle wire fiber in the articulated member. In considering the beaded articulated member, loops of polymeric muscle wire stretches in response to the application of sufficient levels of current. In a no current state the wires are compressed and the tubular structure is retained as a straight segment. Passing a current through the wire causes it to stretch thereby lengthening that side of the tubular structure causing it to flex toward the opposing side. Passing current through adjacent sets of wires relaxes them allowing the tube to flex to a direction opposing the combination. Passing current through all wires causes the entire structure to extend in a straight line, and if sufficient current is supplied the wires can preferably elongate sufficiently wherein the tubular structure substantially goes limp and leans in a direction based in prior position, gravity, wind, or other influence. A central hole allows wires for control signals to pass through the tubular structure to the devices at the end, in this case the laser and camera.

### 2.13 Claim Descriptions.

The following are descriptions of this aspect of the invention written in a claim format.

1. An apparatus for directing the view of an imaging device, comprising:

an elongated flexible member configured for attaching an imaging device to a distal end; and

at least one muscle wire slidably engaged with at least one side of said elongated flexible member and configured to impart curvature to said elongated flexible member in response to contraction of said muscle wire as activation current is passed through said muscle wire.

2. An apparatus as recited in claim 1, wherein said slidably engagement comprises a sheath near the exterior of said elongated flexible member through which said muscle wire is passed and through which it can slide in response to changes in muscle wire length.

3. An apparatus as recited in claim 1, wherein the contraction of a single muscle wire flexes said elongated flexible member in opposition to the bias force produced by said flexible member itself.

4. An apparatus as recited in claim 1, wherein said at least one muscle wire comprises at least one muscle wire loop having two free ends at a first end configured for being physically retained and electrically connected to a source of current drive.

5. An apparatus as recited in claim 1, wherein two segments of muscle wire are slidably engaged on opposing sides of said elongated flexible member for inducing flexure of said elongated flexible member in the plane of said at two segments of muscle wire in response to current passed through said muscle wire.

6. An apparatus as recited in claim 1, wherein at least four segments of muscle wire are slidably engaged periodically about the periphery of said elongated flexible member for inducing flexure of said elongated flexible member in a direction in response to the differential current passed through the muscle wire segments.

7. An apparatus as recited in claim 1, wherein said elongated flexible member comprises stiff segments between which compressible material is retained allowing the elongated member to curve in response to applied forces.

8. An apparatus as recited in claim 7, wherein said stiff segments incorporate passageways through which said muscle wire is routed toward the exterior of said stiff segments.

9. An apparatus as recited in claim 1, further comprising:

an imager attached to the distal end of said elongated flexible member;

a controller circuit to which said at least one muscle wire may be connected for receiving currents for controlling the direction to which said imager at the distal end of said elongated flexible member is directed; and

an image transformation device receiving image signals from said imager and configured to rotate images represented within said image signal in response to position signals from said controller circuit.

10. An apparatus for directing the view of an imaging device, comprising:

a base member;

a plurality of segments having passageways near its periphery;

a mount for retaining an imaging device;

a plurality of muscle wire lengths attached to said base member and slidably threaded through said passageways from said in said plurality of segments and mechanically coupled to said mount;

wherein said segments strung on said muscle wire between said base and said mount form an elongated member;

wherein said base member is configured for coupling a current source to said muscle wire lengths for controlling the contraction of the muscle wire near the periphery of said elongated member regulating its curvature and the direction of said mount.

11. An apparatus as recited in claim 10, further comprising an imaging device attached to said mount.

12. An apparatus as recited in claim 10, wherein said muscle wire lengths comprise muscle wire loops t least two passageways.

### 3 Preponderance-of-Evidence (PROE) Intrusion Detection System and Method

### 3.1 Background.

Conventional detection systems (intrusion, fire, flood, etc.) are configured with separate detector units that individually detect if an alarm condition exists wherein they generate an alarm signal. To reduce subjectivity to false alarms, the sensitivity of the units must be set fairly low (high alarm threshold), wherein measure conditions which are not absolutely conclusive toward an alarm are ignored, wherein an alarm may not be generated when warranted, for example allowing a savvy intruder can go through the detection zones in an alarm system without the alarm being activated.

This type of situation is particularly problematic in security (alarm) systems wherein each zone or layer of detection is often similarly configured with a sloppy threshold, wherein the intruder can bypass each set of detectors in turn to reach their objective.

It will be appreciated therefore that a detection system and method is required which takes into account registered conditions which by themselves are not sufficient to generate an alarm. The present invention fulfills that object and provides a number of additional benefits.

Conventional security detection systems (intrusion, fire, flood, etc.) are configured with separate detector units that individually detect if an alarm condition exists, and in response to which an alarm signal is generated. To reduce subjectivity to false alarms, the sensitivity of the units must often be set fairly low (high alarm threshold), wherein measured conditions which are not absolutely indicative of an alarm are ignored. Consequently an alarm may not be generated as an intruder with a low detection signature passes through a entire series of sensors in different detection zones of an alarm system without the alarm being activated. It will be readily recognized that if the system had taken into account that “near alarm” conditions arising at sequential zones—it would have correctly generated an alarm and foiled the intrusion.

This above situation is particularly problematic in security (alarm) systems wherein each zone or layer of detection is often similarly configured with a sloppy threshold, wherein the intruder can bypass each set of the detectors in turn to reach their objective. Also, in a number of installations, the zones of the detector units overlap but they only generate output based on individual consideration of alarm conditions, instead of the cumulative consideration from the sum of both detector units.

Cost and ease of installation and maintenance are a prime factor in designing security systems. Conventional sensors benefit from being low in cost and easy to install, while they do not require any programming as to the specific location or interdependencies between sensors.

It will be appreciated therefore that a detection system and method is required which takes into account registered conditions which by themselves are not sufficient to generate an alarm. The present invention fulfills that objective of tighter thresholding while maintaining low cost and simple setup factors as well as a number of additional benefits.

### 3.2 Summary of Inventive Aspects.

This invention pertains generally to alarm systems and more particularly to a system and method for preconditioning sensor thresholds.

The present invention describes a system and method wherein sensors, in addition to having the ability to generate an alarm condition, can generate a “prequalification” for an alarm. The prequalification being generally based on a lower threshold of the detector (more sensitive than threshold for directly generating an alarm). Conditions which cause the lower threshold to be crossed suggest the presence of an intruder, but are insufficiently conclusive by themselves to warrant generating an alarm.

The prequalification signal is utilized for temporarily lowering the alarm output threshold which when crossed leads to outputting of an audible and/or silent alarm. It should be appreciated that although alarm systems conventionally activate an alarm bell, or similar annunciator, in response to detecting an alarm; they may alternatively generate a number of other forms of output. Within the present invention the phrase “outputting an audible and/or silent alarm” is meant in a broad sense as any output from the controller which can alert personnel, such as annunciating an alarm condition with lights or sounds, generating an output that is registered by a remote system for alerting personnel, or other mechanisms in which people are directly or indirectly alerted to the condition.

The step of lowering the alarm detection threshold in response to one or more prequalification signals can be performed by a control circuit or system, such as a controller, which registers inputs from more than one sensor, or sensors which receive prequalification from other sensors, such as neighboring sensors.

The present system is configured with a controller for generating an output alarm signal upon the receipt of an alarm sensor signal from any one sensor, OR upon the receipt of prequalification signals from multiple detector units within a given period of time. The prequalification signal from multiple detectors provides a Preponderance-Of-Evidence (PROE) that an alarm condition indeed has arisen although the conditions at any one sensor may not exceed the alarm threshold.

It should be appreciated that sensors (alarm condition detectors) manufactured for providing a prequalification signal can be easily integrated within conventional alarm systems in a number of different ways. The prequalification units can be utilized alongside of legacy alarm detection sensors, and/or alongside of legacy controllers, while providing enhanced functionality. By way of example, a simple single current loop alarm communication link, can contain conventional switch sensors (i.e. magnet and reed relay switch combination to sense door and window operation), while also incorporating other detector units which can generate prequalification signals and are coupled to the same current sense loops. The ease with which the present PROE teachings can be incorporated within a detector unit which already contains some form of signal processing/thresholding circuitry should be readily appreciated.

The present invention of a preponderance of evidence security system can be generally described as a system for generating intrusion alarms in response to registered conditions, comprising: (a) a plurality of condition (intrusion) detectors configured for registering conditions warranting or indicative of a given condition such as an intrusion or fire); (b) an alarm detection circuit within the condition (intrusion) detector for generating an alarm signal for conditions crossing a first threshold (over or under a predetermined, parametric, or variable threshold; (c) a prequalification circuit within said alarm detection circuit which is configured to generate a prequalification signal in response to conditions which exceed a second threshold but which do not exceed said first threshold; and (d) a controller circuit coupled to said plurality of intrusion detectors and configured to generate an alarm in response to detecting an alarm signal from any detector, or in response to the receipt of multiple prequalification signals.

The number of prequalification signals that must be received prior to an alarm signal being generated depends on the configuration of said controller and the level of the prequalification signal (if more than one level is supported). It is preferable that the user can select the number of prequalification signals needed. Furthermore, the time period for which a received prequalification is held for comparison purposes is preferably selectable by the user depending on the conditions, with a range of from 1 second to 5 minutes, or more depending the sensor type and its percentage propensity to generate false alarms. In addition the system can be configured to ignore prequalification events which occur simultaneously, such as on sensors in different areas to which the only simultaneous event that could trigger both would be related to ambient conditions and power line conditions.

The method of generating an alarm signal in response to signal from multiple detector units may be described as comprising: (a) registering conditions at one of a plurality of detector units; (b) comparing said registered condition to an alarm threshold; (c) generating an alarm signal if said registered condition crosses said alarm threshold; (d) comparing said registered condition to a prequalification threshold signal if said registered condition did not cross said alarm threshold; (e) generating a prequalification signal if said registered condition crossed said prequalification threshold; and (f) generating an alarm signal in response to the receipt of a sufficient number of prequalification signals.

The prequalification threshold in the above case preferably comprises a threshold between that of a nominal, non-alarm state, and said alarm threshold. The thresholds may be predetermined values, values based on system or user parameters, variables based conditions or other system aspects, and so forth.

### 3.3 Detailed Description.

The present invention describes a system and method wherein sensors, in addition to having the ability to generate an alarm condition, can generate a “prequalification” for an alarm. The prequalification being generally based on a lower threshold of the detector. Conditions which cause the lower threshold to be crossed suggest the presence of an intruder, but are insufficiently conclusive evidence by themselves to warrant an alarm.

The present system is configured with a controller for generating an alarm signal upon the receipt of an alarm signal from any one sensor, OR upon the receipt of prequalification signals from multiple detector units within a given period of time. The prequalification signal as received from multiple detectors is used by a controller circuit, or thresholding circuit, in determining if a PReponderance-Of-Evidence (PROE) exists, for generating an alarm signal.

### 3.4 Simple Embodiment of Preponderance Sensing.

A simple method of utilizing prequalification with conventionally wired detectors is that of embedding a recognizable characteristic in the signal. For example for detectors with a two-wire resistive output (i.e. closed switch=no alarm, open switch=alarm) the resistive contact can be modulated in response to prequalification allowing it to be distinguished from an alarm condition. For example, the switched output can be modulated at a high rate, preferably according to a predetermined pattern so that intermittent alarm output can be readily distinguished from prequalification.

On detectors which generate voltage outputs back to a controller, the prequalification can be generated as an opposing polarity signal, a specific voltage level, a signal superimposed on the voltage signal, or similar detectable variations which can be distinguished from non-alarm or alarm conditions.

Other detectors can generate any convenient signal which allows discerning the prequalification signal from an alarm signal. Wireless sensors can generate transmissions containing analog or digital signals which are associated with the prequalification signals, or additionally, the alarm sensor signals. It should be appreciated that the conventional alarm sensor signals could be communicated over a wired link with the prequalification signals communicated in an area mode using wireless communication, therein not requiring wired interconnections between ostensibly different types of alarm systems, which may not otherwise be commonly wired to a controller.

The controller of the alarm system is configured to detect the alarm signals, which may be performed conventionally, and to sense prequalification signals which when combined indicate, based on a preponderance of evidence that an alarm condition exists. Typically, the separate detectors are spaced out over a distance, wherein the prequalification output of the detectors in response to an intruder movement would be temporally displaced. In a simple embodiment, the controller is configured to register the prequalification signal and mark the time of receipt. If another prequalification signal is received, preferably from another sensor, within a predetermined period of time then the controller takes this as being sufficient evidence to generate an alarm.

It should be appreciated that using this preponderance of evidence mode improves the sensitivity of the alarm system without making the alarm system subject to increased false alarms, as would arise if the sensitivity on the sensors were increased. Furthermore, the relationship between detectors is taken into account without the need to program an alarm system to recognize specific relationships between the detector units.

FIG. 19 illustrates a block diagram 510 of the PROE approach according to the present invention. An environment has multiple sensors, herein shown simplified as two sensors 512a, 512b, although any number of sensors, detectors, or other detection units may be supported.

The condition being sensed is not naturally a binary value (alarm/no alarm) but is subject to intensity or other interpretation, represented by sensor outputs being represented as a multistate output, such as an analog voltage, which is shown being received and processed by threshold comparators. It should be appreciated that the sensor may be comprise any form of sensor from simple to sophisticated that can provide a “fuzzy” output representing the quality or intensity of the detected condition. For example, a pyroelectric detector can provide an output voltage according to the amount of activity registered. As another example, a complex video imaging system which utilizes signal processing to detect dangerous conditions, intruders, muggers, vandalism, and so forth generates an output based on the amount of certainty that a dangerous event (or any condition for which detection is desired) has been detected. In addition a combination of sensors can provide multistate output, for example a conventional window switch sensor coupled to an acoustic glass breakage sensor.

Comparators 514a, 514b, connected to the two sensors shown detect if sufficient “certainty” exists to generate an alarm. In the case shown the sensor input is compared against a predetermined voltage as set by resistive voltage divider which divides the voltage between a voltage reference (i.e. zener diode) and the supply voltage with an alarm threshold and a prequalification threshold. Comparators 516a, 516b compare the “certainty” against the prequalification threshold. If the threshold condition is met in either case then an alarm signal or a prequalification signal is generated.

Alarm signals or prequalification signals are communicated over a communication link 518a, 518b to a controller 519, herein represented as simple digital logic functions representative of basic PROE operation. Alarms detected on either sensor 512a, 512b, are communicated over communication link 518a, 518b to be received by the controller 519 which generates an alarm output through OR function 520 in response to any alarm conditions.

Prequalification signals received within controller 519 are stretched over a period of time (as events which collectively qualify for an alarm are not necessarily simultaneous). This is represented by an active prequalification signal triggering a set-reset flip flop 522a, 522b, whose output triggers a one-shot timer 524a (monostable multivibrator) whose time is controllable, depicted via an RC network. The prequalification signal is thereby stretched out to any desired length, so that prequalification activity on one channel can be compared with prequalification on others channels that doesn't need to occur at the same time. When multiple prequalifications have occurred within a timeframe set by the timers, then the conditions for AND function 526 are met which generates a signal that activates the alarm through OR function 520.

It will be appreciated by one of ordinary skill in the art that the system may be implemented in a number of alternative ways without departing from the invention. The above block diagram discussion provided as an overview of basic functionality. By way of example microprocessors, or other forms of digital processing elements, may be utilized to process inputs which are coded with multistate information, such as PWM for prequalification signals and steady state for an alarm condition which crosses the threshold.

The implementation of thresholding depends on the type of sensors being utilized and their output. Analog sensors for example may produce a voltage or current (or other measurable electrical characteristic) output that may be subject to a simple comparator ladder as shown. Digital sensors (or analog sensors subject to A/D conversion and digital post processing) may directly produce alarm and prequalification signals. The communication link utilized depends on the configuration of the system. A security system may connect a series a number of pyro sensors, or similar, in parallel from a voltage source wherein the voltage source supplies current to operate the unit the signals from which are coupled through the connection (voltage or current modulation). By way of example the sensor may shunt the voltage source (exceeding normal current draw levels) to signal an alarm, wherein it may modulate the shunts at high rate to signal a prequalification or it may otherwise modulate the line, such as using a transformer and inducing an AC signal on the DC voltage supplied. One of ordinary skill in the art will appreciate that numerous alternative forms of signaling may be adopted. As a further example, standard forms of digital communication links may be utilized, (i.e. CAN, IP, RS-232, etc.).

One preferred method of implementing controller 519 is with a microcontroller that internally registers prequalification activity and tracks the relative time between prequalification events for determining if an alarm is to be generated. The prequalification values may be divided into discrete weighted levels wherein the controller can operate with any sensor equipped for detecting and communicating the prequalification levels without the need to recognize the specific type of sensor and be adjusted for it.

It is contemplated that the present invention will be standardized so that equipment from various manufacturers can be intermixed without regard for type. By way of example, assume that the standard defines 7 levels (1-7) of prequalification. A sensor maker that only supports a single prequalification threshold (i.e. indicative of at least a 50% probability of proper event recognition) can generate a prequalification signal with a value of 4, wherein in combination with another similar sensor detecting a prequalification level an alarm event output is generated.

3.5 Requiring Prequalification from Different Detectors.

If it is generally desirable to prevent temporally proximal prequalification signals from a single detector from causing an alarm. One means of accomplishing this is that each detector can be configured to generate a prequalification signal that may be distinguished from one unit to the next. For example, the output signal may be modulated with a specific pattern, such as with a detector module ID that can be provided on an ID chip or similar within the detector. Alternatively, a bus can be established between sensors having internal identifiers, wherein a controller can query each sensor in the system to collect its specific level of prequalification or alarm.

### 3.6 Communication of Prequalification Signals.

Communication between the detector units and the alarm controller may be performed over substantially conventional analog wiring as described, or it may be communicated over any form of electronic communication interface, or network either wired or wireless. For example, the sensors could communicate according to CAN protocols utilized in the automotive industry, IP protocols, or any other communication mechanism for transmitting a prequalification signal from the detector unit to the alarm controller. Utilizing these more sophisticated protocols would typically entail increased costs per sensor station, unless the signals were already being utilized by compatible circuitry.

### 3.7 Extending Prequalification Information.

The prequalification information is described above as a binary value, either the conditions warrant prequalification or they do not. However, the prequalification may be provided as multiple levels of prequalification, wherein the preponderance of evidence can require a sum of prequalification signals that exceeds a given threshold. For example each detector generating four level of prequalification (1, 2, 3, 4) wherein prequalification exceeding about 5 or 6 is required to generate the alarm.

Furthermore, the prequalification signals may include “type of intrusion” information wherein the type is factored into alarm prequalification, or multiple categories of prequalification information are generated.

These additional levels of signaling can be communicated over conventional wiring, such as utilizing embedded signal forms or using other communication methods.

It should be appreciated that the above prequalification signals can be utilized without the need to program the alarm controller for specific relationships between detectors or the like.

3.8 Combining Prequal. with Alarm System Configuration Information.

To provide additional distinction from the detectors, the prequalification information can be utilized in combination with parameters set for the specific alarm installation. For example, selecting specific temporal relationships between prequalification signals, or even between specific detector units. The use of the prequalification signals can be extended to allow the installer/user to control how the alarm system uses prequalification in determining if an alarm is to be generated.

### 3.9 Prequalification Induced Threshold Lowering.

Prequalification can be sensed within any element of the alarm system which is capable of generating an alarm or of otherwise altering the conditions under which an alarm is generated. Two preferred approaches are generally described in the disclosure, although it should be appreciated that the teachings may be applied to other forms of implementation without departing from the present invention.

(1) The prequalification may be detected within a controller which generates an alarm in response to a signal from any sensor indicating the alarm threshold is crossed, or multiple sensors generating a prequalification signal.

(2) The prequalification may be detected within other alarm detector units (i.e. sensor heads, etc.) wherein receipt of the prequalification signal temporarily lowers the threshold that must be crossed for generating an alarm, since the detected condition has already been prequalified.

Furthermore, in some applications it may be desirable to use the prequalification for prequalifying one or more given alarm signal outputs from select alarm detectors (or certain alarm detector outputs on an alarm detector) which are prone to false alarm, wherein a prequalification signal would need to first be received before an alarm indication from the selected alarm would be considered a valid alarm and a audible or silent alarm output from the system. It will be appreciated that an alarm detector may generate unreliable output or that the communication path to the controller may be subject to noise, especially with regard to the use of wireless detectors, which could erroneously appear as an alarm condition. The prequalification can allow for increasing the sensitivity of an alarm system while significantly reducing the occurrence of false alarms. Still further, the prequalification can be implemented as an add-on to existing sensors to increase false alarm immunity, by requiring the presence of prequalification data to verify an alarm, which results in increasing the available signal and threshold for the particular alarm.

3.10 Synchronous and/or Asynchronous Prequalification.

The desired response to prequalification within the system can be configured as synchronous and/or asynchronous.

Synchronous response requires that the prequalification signal be active at the same time as another signal, such as a prequalification level signal, or other signal being qualified by the prequalification signal. This mode is most suitable when multiple sensors are directed at a given alarm zone.

Asynchronous response allows the prequalification signal to be temporally displaced from the other signal being prequalified. Receipt of the prequalification signal thereby alters the threshold for some period of time, which may be predetermined or a variable whose value is determined during alarm configuration for all or a single detector or set in response to detected conditions. This mode is suitable to all arrangements and it allows the benefits of prequalification to be applied to nested sensors.

### 3.11 Levels of Prequalification Information.

The prequalification information is generally described above as a binary value, either the conditions warrant prequalification or they do not. However, the prequalification may be extended into multiple levels (preferably discrete levels) of prequalification wherein the preponderance of evidence can require a sum of prequalification signals that exceeds a given threshold. For example consider a system in which each detector can generate four levels of prequalification (1, 2, 3, 4) and in which prequalification exceeding 5 or 6 is required to generate the alarm. In at least one embodiment, the prequalification level generated by a sensor and the amount of prequalification required to initiate an alarm activation may be configured as settings by the user (i.e. switch settings, detented potentiometers, buttons, software settings, etc.).

Furthermore, the prequalification signals may include “type of intrusion” information wherein the type is factored into alarm prequalification, or multiple categories of prequalification information are generated. In this way the system can be balanced so that certain types of sensors, such as prone to a disturbance from RF sources, can require prequalification from alarm detectors which are not subject to the same false alarm condition.

These additional levels of signaling can be communicated over conventional wiring, such as utilizing embedded signal forms or using other communication methods.

It should be appreciated that the above prequalification signals can be utilized without the need to program the alarm controller for specific relationships between detectors or the like, although specific relationships could be established if desired.

3.11.1 Communication of Prequalification.

A simple method of utilizing prequalification with conventionally wired detectors is that of embedding a recognizable characteristic in the signal. For example for detectors with a two-wire resistive output (i.e. closed switch=no alarm, open switch=alarm) the resistive contact can be modulated in response to prequalification allowing it to be distinguished from an alarm condition. For example, the switched output can be modulated at a high rate, preferably according to a predetermined pattern so that intermittent alarm output can be readily distinguished from prequalification.

On detectors which generate voltage outputs back to a controller, the prequalification can be generated as an opposing polarity signal, a specific voltage level, a signal superimposed on the voltage signal, or similar detectable variations which can be distinguished from non-alarm or alarm conditions. It should be appreciated that prequalification signals can be communicated by any convenient encoding means to a controller.

In many implementations it may be preferable that the detector units delay their output of a prequalification signal so that it does not overlap a prequalification signal sent by another unit. This involves merely delaying prequalification output until the no signal is detected on the alarm communication link.

Communication between the detector units and the alarm controller (or other detector units whose output is responsive to prequalification) may be performed over substantially conventional analog wiring as described, or it may be communicated over any form of electronic communication interface, or network, either wired or wireless. For example, the sensors could communicate according to CAN protocols utilized in the automotive industry, IP protocols, or any other communication mechanism for transmitting a prequalification signal from the detector unit to the alarm controller. Utilizing these more sophisticated communication links, additional information is more easily conveyed within the PROE signals, such as supporting levels of prequalification.

3.11.2 Controller Processing of Prequalification.

In one embodiment the controller of the alarm system is configured to detect the alarm signals, a process which may be performed conventionally, as well as to sense prequalification signals according to the present invention which when combined indicate, based on a preponderance of evidence, that an alarm condition exists. Typically, the separate detectors are spaced out over a distance, wherein the prequalification output of the detectors in response to an intruder movement would be temporally displaced. In a simple embodiment, the controller is configured to register the prequalification signal and mark the time of receipt. If another prequalification signal is received, preferably from another sensor, within a predetermined period of time then the controller takes this as being sufficient evidence to generate an alarm.

It should be appreciated that using this preponderance of evidence mode improves the sensitivity of the alarm system without making the alarm system subject to increased false alarms, as would arise if the sensitivity on the sensors were increased. Furthermore, the relationship between detectors is taken into account without the need to program an alarm system to recognize specific relationships between the detector units.

3.11.3 Requiring Prequalification from Different Detectors.

A number of alternative mechanisms within the invention can be utilized if it is desirable to prevent temporally proximal prequalification signals from a single detector from causing an alarm. By way of example two mechanisms are described (1) including detector unit information with the prequalification signal; (2) preventing a detector unit from generating prequalification signals with insufficient time separation.

(1) Encoding Detector Unit Number within Prequalification.

By including a detector unit number encoded within each prequalification signal, then the output of each detector unit can be distinguished by the controller, or alternatively by neighboring detector units, or other circuits on the alarm communication link. For example, the prequalification output signal may be modulated with a specific pattern, such as with a detector module ID that can be provided from an ID chip, switch setting, configuration data, or similar means of retaining an ID within the detector unit. These detector unit IDs can also be encoded with each alarm signal, wherein the controller can make more intelligent decisions about both prequalification and alarms, such as in high-end alarm applications, by considering the relationship between the signals received in view of system topology.

(2) Not Encoding Detector Unit Number within Prequalification Signals.

If the prequalification signal to the controller is not encoded with detector unit number, then it may be preferred in some cases that the system prevent multiple prequalification signals from a single source from generating an alarm. Alternatively, one may want to allow temporally separate prequalifications to generate an alarm, depending on the type of detector is being considered. Sequential prequalifications on the same sensor can provide extra evidence of intrusion, insofar as the type of sensor is not one prone to noise levels that cause sporadic triggering.

In this instance it is preferable that multiple detector units upon generating a prequalification signal not be allowed to generate another such signal for a period of time, such as equal to the time period the prequalification is being considered by the controller or other detector. For example consider that the prequalification is to be considered valid at the controller for a period of 60 seconds after arrival of a short prequalification signal (i.e. approximately 1-100 mS on an analog current loop form of alarm communications link).

A first detector unit detects alarm conditions (i.e. intrusion) conditions that are significant and which exceed the prequalification threshold, but the conditions are not quite sufficient to generate an alarm as they do not exceed the alarm threshold. Thereby the first detector unit generates a prequalification signal to the controller and will lock itself out from generating additional prequalification signals for a period of time, such as for 60 seconds. In this case consider that the controller stretches internally (i.e. by analog or digital hardware means or by way of programming) each received prequalification signal as if it lasted for 60 seconds. In this way the controller could only elevate multiple prequalification signals to an alarm condition if the prequalification signals were received from two different detector units. The prequalification lockout period need not be equal to the prequalification period of consideration within the controller, depending on the characteristics of the specific detector and system, for example a 30 second lockout may be sufficient to prevent the false alarms.

3.11.4 Generating Unit ID from Detectors.

Detector units, preferably those configured for generating a prequalification signal, but applicable to any detector unit, may be adapted to periodically generate a short unit ID (which may be optionally encrypted) for indicating to the controller that it is still operational and connected within the system. This feature provides the benefit of testing the output of the sensors, and of detecting if any of the sensors have been disabled from the alarm system. The rate at which the detector unit ID should be transmitted depends on the type of communication link utilized, but by way of example may be configured so each unit generates an ID every 1-10 seconds. This increases the security of the unit while simplifying maintenance and testing. It will be appreciated that any convenient encoding technique for transmitting the ID signal may be selected, and many such techniques are known to those skilled in the art.

3.11.5 Combining Prequalification with Alarm System Configuration Information.

The use of unit numbering within the prequalification signals and optionally alarm signals can provide additional distinction of individual detector units, wherein the prequalification information (and optionally alarm information) can be utilized in combination with parameters set for the specific alarm installation. For example, selecting specific temporal relationships between prequalification signals, or even between specific detector units. The use of the prequalification signals can be extended to allow the installer/user to control how the alarm system uses prequalification in determining if an alarm is to be generated.

3.11.6 Separate Communication of Prequalification and Alarm Signals.

It should also be appreciated that the alarm signal output and prequalification signal output may be generated by different means. For example the alarm signal output may be generated conventionally over a current loop, while the prequalification signals are generated by wireless transmissions. The prequalification signals can be received by all detector units, or selected detector units, which in response to the alarm being “prequalified” lower their alarm threshold, or by a controller that is configured to generate an alarm condition output upon receipt of sufficient prequalification information.

### 3.12 Second Embodiment of System.

FIG. 20 depicts a block diagram of a preponderance of evidence system (PROE) 610 configured for operating over a single current loop. A generally conventional current loop 612 is shown, upon which a number of detector unit outputs are coupled. An example embodiment of a detector 614 according to the invention is shown connected to the current loop 616 which is connected to a controller 618 also according to an aspect of the present invention.

Detector 614 senses conditions toward recognizing that an alarm condition exists (i.e. intruder, fire, flood, etc.) by means of sensor 620 and conditioning circuitry 622. The sensed output is then checked against a threshold to determine if it indicates that an alarm condition exists; or if alarm conditions indicate that something may be occurring but it is not quite certain—wherein prequalification threshold conditions may be met. The thresholding is exemplified by two comparators 624a for sensing if the alarm condition threshold is exceeded, and 624b for sensing if the prequalification threshold condition is exceeded. It should be appreciated that the circuit is shown as a representation as numerous mechanisms exist for comparing the extent, or qualify of signals, and processing may be performed with analog circuits, digital circuits, signal processing circuits, microprocessors, and combinations thereof without departing from the teachings herein.

An encoder 626 is utilized for encoding any detected alarm and prequalification conditions into the proper format for output on the communication link to the alarm controller, or alternatively to other detector units configured to register prequalification. The encoding in the present example would provide opening the current path in the current loop for a time tₐₗₐᵣₘ>t_{threshold} to indicate an alarm condition, or modulating switch state for a period much less than t_{threshold} to indicate a prequalification signal. It will be appreciated that the switch state can be modulated to encode a detector unit number and/or additional information such as a discrete prequalification level.

The encoded alarm or prequalification signal output is then transmitted from a switch 628 in series on current loop 612. It should be appreciated that numerous forms of communication links may be alternatively utilized instead of the simple current loop shown. The switch output stage from a number of other detector units is shown 630a-630d, which may be legacy devices (i.e. magnet-switch combinations, or other detectors without prequalification techniques) or devices according to the present invention.

Although it is preferred that at least two detector units providing prequalification output should be connected in the system to advance prequalifications from different detector units to an alarm state, a single detector unit with prequalification may be properly utilized so long as the system can advance multiple prequalifications from the same unit to an alarm state. The present invention in any case is compatible with legacy devices whether or not the prequalification signals are utilized.

A controller 618 receives the sensed alarm conditions at a decoder 632 which registers alarms, shown from output 634, and prequalification signals, shown from output 636. A simple mechanism is shown for advancing multiple prequalification signals to an alarm condition. A received prequalification signal is delayed by delay-timer 638 and then the duration of the prequalification is stretched to a desired length by monoshot 640. If another prequalification signal arrives while the output of monoshot timer 640 is active, then the prequalification is advanced to an alarm, by virtue of AND-gate 642. Alarms generated as a result of prequalification and regular alarms are combined with OR-gate 644 and then output as an alarm through output stage 646.

It should be appreciated that the logic shown in a functional block form can be implemented as discrete or integrated (i.e. ASIC) analog circuits, or utilizing processor based elements, such as microcontrollers, microprocessors, signal processors and the like.

Another mechanism for summing prequalification signals is to input fixed duration prequalification signals onto an integrator, wherein if sufficient signals arrive within a given period then the conditions are met. Furthermore, the detector units can encode the level of prequalification into the duration of the prequalification signals which is sent over the communication link, received at the controller and integrated on the integrator. In this way levels of prequalification are readily supported. It should be appreciated that any of a number of ways may be utilized to detect multiple prequalifications and to advance those multiple prequalifications to an alarm.

FIG. 21 depicts an example of an alternate prequalification decoding mechanism 650 based on the inclusion of a detector unit ID within each prequalification transmission. In this example the decoder extracts the unit ID and generates a separate output for each detector unit which are stretched by monoshot timers 654a-654n to a desired prequalification interval. The stretched signals are then input to a summer 656, which preferably goes active in response to a sufficient level of prequalification. The level of prequalification may be fixed, or a selection input 658, may be provided to allow configuring how much prequalification is required before advancing an alarm. Alarms from prequalification and alarm signal detection are combined at OR-gate 644 to arrive at an alarm output signal for triggering audible alarms, silent alarms, monitoring systems, communication systems (i.e. communicating alarm over a modem), other alarm mechanisms and combinations thereof.

It should be appreciated that the described aspects of the invention may be implemented separately or in various combinations thereof. In addition a number of optional elements are described which need not be implemented within each embodiment of the present invention.

### 3.13 Claim Descriptions.

The following are descriptions of this aspect of the invention written in a claim format.

1. A system for generating intrusion alarms in response to registered conditions, comprising:

an intrusion detector configured for registering conditions indicative of intrusion;

an alarm detection circuit within said intrusion detector for generating an alarm signal in response to a condition, or conditions, which exceed a first threshold;

wherein said alarm detection circuit is configured to generate a prequalification signal in response to conditions which exceed a second threshold but which does not exceed said first threshold, and

a controller circuit configured for coupling to at least two said intrusion detectors and configured to generate an audible and/or silent alarm in response to detecting an alarm signal from any detector, or in response to the receipt of more than one prequalification signal.

2. A system as recited in claim 1, wherein said more than one prequalification signal must be generated from different intrusion detectors as a condition for generating said alarm.

3. A system as recited in claim 2, wherein said intrusion detector comprises means for unit identification within said system, allowing said controller circuit to distinguish which intrusion detector transmitted a given prequalification signal.

4. A system as recited in claim 1, wherein said controller circuit is configured to register the receipt of said prequalification signal and to extend the applicability of the prequalification over a predetermined or variable period of time when determining if more than one prequalification signal is being received.

5. In an alarm system having multiple sensor units coupled to a controller which generates an audible and/or silent alarm when an alarm conditions is communicated from one or more sensors, wherein the improvement comprises:

communicating a prequalification signal from said sensor units to said controller in response to detecting conditions which exceed a threshold below that necessary for generating an alarm; and

generating said audible and/or silent alarm in response to said controller receiving multiple prequalification signals.

6. In an alarm system having multiple sensor units coupled to a controller which generates an audible and/or silent alarm when an alarm signal is received from one or more sensors in response to sensed conditions exceeding an alarm threshold, wherein the improvement comprises:

communicating a prequalification signal from one of said sensor units to other sensor units in response to sensing conditions which exceed a threshold that is more sensitive to conditions than said alarm threshold; and

lowering the alarm detection threshold for said other sensor units in response to receipt of said prequalification signal, wherein said audible or silent alarm can be generated by said controller in response to conditions on any one single sensor that does not exceed said alarm threshold.

7. A method of detecting an alarm condition, comprising the steps of:

(a) generating an alarm signal, from at least one detector unit within a plurality of detector units, in response to sensed conditions exceeding an alarm threshold;

(b) generating an alarm prequalification signal, from at least one detector unit within a plurality of detector units, in response to sensed conditions exceeding a prequalification threshold which is below said alarm threshold;

(c) outputting an alarm condition in response to receipt of at least one alarm signal from said detector units, or the receipt of a sufficient number of alarm prequalification signals from said detector units.

8. A method as recited in claim 7, wherein said prequalification threshold having a threshold below said alarm threshold is indicative that it has a higher probability of generating an output when an alarm condition does not actually exist, thereby the signal is not sufficient in itself to warrant an alarm but used as an alarm qualifier in combination with other conditions.

9. A method as recited in claim 7, wherein said sufficient number of prequalification signals comprises two prequalification signals.

10. A method as recited in claim 9:

further comprising generating discrete levels of prequalification signal in response to associated levels of prequalification threshold;

wherein said sufficient number of prequalification signals is determined by summing the received levels of prequalification signal.

11. A system for generating intrusion alarms in response to registered conditions, comprising:

a plurality of intrusion detectors configured for registering conditions indicative of intrusion;

an alarm detection circuit within said intrusion detector for generating an alarm signal for conditions exceeding a first threshold;

a prequalification circuit within said alarm detection circuit which is configured to generate a prequalification signal in response to conditions which exceed a second threshold but which do not exceed said first threshold; and

a controller circuit coupled to said plurality of intrusion detectors and configured to generate an alarm in response to detecting an alarm signal from any detector, or in response to the receipt of more than one prequalification signal.

12. A system as recited in claim 11, wherein said more than one prequalification signal must be generated from different intrusion detectors as a condition for generating said alarm.

13. A system as recited in claim 12, wherein said intrusion detector comprises means for unit identification within said system, allowing said controller circuit to distinguish which intrusion detector transmitted a given prequalification signal.

14. A system as recited in claim 11, wherein said controller circuit is configured to register the receipt of a prequalification signal and to consider it as having extended forward for a predetermined period of time when determining if more than one prequalification signal is being received.

15. A method of generating an alarm signal in response to signals received by a controller from multiple detector units, comprising:

(a) registering conditions at one of a plurality of detector units;

(b) comparing said registered condition to an alarm threshold;

(c) generating an alarm signal if said registered condition crosses said alarm threshold;

(d) comparing said registered condition to a prequalification threshold signal if said registered condition did not cross said alarm threshold;

(e) generating a prequalification signal if said registered condition crossed said prequalification threshold; and

(f) generating an alarm signal in response to the receipt of a sufficient number of prequalification signals.

16. A method as recited in claim 15, wherein said prequalification threshold comprises a threshold between that of a nominal, non-alarm state, and said alarm threshold.

4 eInk Stamp—Programming with Selected Messages for eInk Areas.

### 4.1 References.

Incorporated herein by reference is regular utility patent application Ser. No. 10/612,777 filed Jul. 1, 2003 and related provisional patent application 60/394,160 filed Jul. 1, 2002.

### 4.2 Background.

Inked stamps are for marking both personal and business documents. Examples of common stamps include: “PAID”, return address, “Received O” date stamps, “COPY”, “Proprietary”, and so forth. Currently individual stamps are purchased with preprogrammed messages with separate or integrated ink retention that must be periodically inked. These stamps have limited utility and are often messy, and once programmed can not be rewritten.

### 4.3 Summary.

An electronic ink stamp with a similar look and feel as conventional pressure applied ink stamps. The unit is pressed onto a surface containing electronic ink, wherein it “stamps” a message from memory, or received from an external device, onto the surface as state changes of the electronic ink. The stamp unit has a grid of electrodes and configured for “stamping” text and/or graphics onto surfaces containing spheres of electronic ink, or similar materials with voltage field responsive optical properties that remain static after the voltage field is removed. A common electrode is also retained under the electronic ink, either deposited beneath the electronic ink, or as a separate voltage plane for retention behind the area of electronic ink. (alternatively, the plane can be in front with individual pixel electrodes providing programming from the rear)

A number of messages can be preloaded onto the stamp which are user selected. Preferably the unit is also configured for interfacing with a computer, PDA, or similar computational device having a user interface. It may be interfaced by wire, or wireless communication.

### 4.4 Detailed Description.

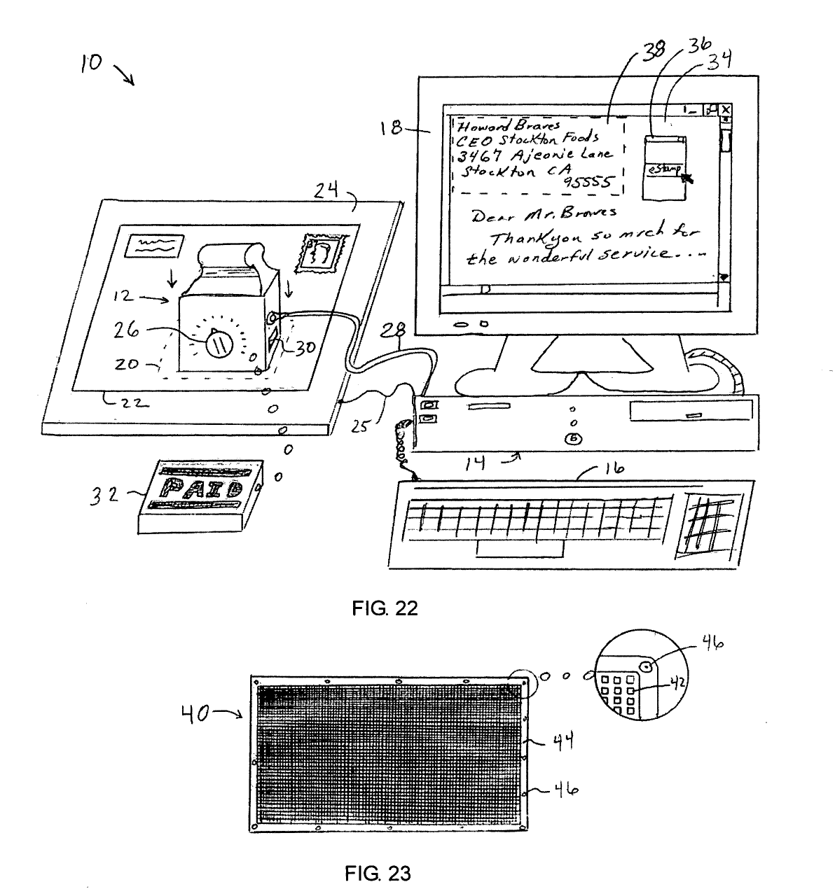

FIG. 22 illustrates an embodiment 710 of the electronic ink stamp device 712 shown connected to a programming means in the form of a computer 714 with keyboard 716 and display 718.

Electronic ink stamp device 712 is depicted positioned for stamping information on a field 720 of electronic ink upon envelope 722 to which postage and return address have already been attached. It will be appreciated that the stamp device may be utilized for adding return addresses or electronic postage to an envelope. For example electronic postage is added by writing the indicia over a area of electronic ink on the envelope (or other form of mailing package). Once positioned, the user presses down on the unit wherein the state of the electronic ink is set to the message by applying sufficient voltages to each of the pixel electrodes and to the common electrode. It will be appreciated that areas of electronic ink can be programmed to either of at least two states (i.e. typically either “set” to a color, or “reset” to white, or other background color).

A common electrode may be fabricated beneath the label of electronic ink to which the stamp unit makes contact upon pressing the stamp unit down upon the label. For example a surface of the envelope (paper, bag, or other article) may be plated with sufficient nickel (i.e. similar to that applied to conductive nickel bags used for static protection), or other conductive material. An optional primer layer may be applied over the common electrode if desired, and the electronic ink layer added, over which another optional protective layer may be applied.

The method of operation preferably comprises: (a) detecting user applied pressure exceeding a threshold; (b) detecting continuity between at least two common electrode contacts; (c) outputting a proper voltage to all common electrode contacts; (d) outputting a programming voltage for a sufficient programming interval to each pixel in response to a message pattern retained in memory; (e) switching off programming voltages. Optionally, the end of the cycle can be annunciated, such as with an audio annunciator, LED output, or other form annunciator, letting the user know they can remove pressure and lift the stamper. If the user made a mistake, they can simply reposition the stamp unit and restamp another message on the material.

Alternatively, the common electrode need not be contained within the area to be stamped, but may be on a conductive surface 724, shown connected 725 to the computer as a source of ground voltage (about which the pixelated programming voltage are set (+/−) to allow setting areas of electronic ink in either desired state).

A message selector 726 allows the user to select which message is to be output on the electrodes of the electronic stamp. These messages can be preprogrammed, such as shipped with the unit, downloaded from a web site of stamp patterns, or created by the user for a single use or repeated use, captured by the user from a screen image shown on a computer screen, PDA, email. A cable interface 728 is shown connecting to a computer, such as an RS-232 interface, USB interface, and so forth. The cable interface can be left attached to the unit, wherein the user can pop up a screen of messages and select from them for immediate or later use. A wired or wireless port 730 may be alternatively incorporated allowing communication with an external device, via wireless RF (i.e. Bluetooth™), Infrared link, and so forth, or using a wired link, such as through USB port 730. The wired link can be used temporarily, wherein the user connects the stamp unit to the computer, such as a USB port, and then loads message data onto the stamp unit. The unit can then be removed and used for stamping. Any desired form of selector may be utilized on the unit. A simple push button may be utilized for selecting from preprogrammed messages, while the multiposition selector shown allows the user to reprogram any selected stamp message within the set of messages stored on the unit. Optionally, a small display (i.e. eInk, LCD, OLED, etc.) can be incorporated to display the currently selected stamp image, allowing a user to readily switch messages, such as pressing a button to scroll through a set of images, or select a category followed by an specific stamp image.

Although a display may be incorporated to allow the user to see the patterns, it is preferable that a cover 732 be adapted with electronic ink wherein each time the position of the selector is changed with the cover on the electronic ink is written with the new pattern, allowing the user quickly find the desired stamp pattern. The case is preferably configured to sense that cover 732 is attached, such as a switch, conductive path, or so forth, wherein the operation changes based on presence of cover (i.e. such as outputting pattern immediately upon changing pattern, and mirror imaging the pattern for proper viewing by the user). The cover preferably has the electronic ink deposited on the inner surface with a transparent ground plane over the exterior providing the opposing electrode that is retained at a particular voltage in relation to the programming voltage on the pixelated electrodes.

In the figure, computer display 718 is shown with an application display 734 from which the user has performed a right click to pop up a function screen 736 from which they selected a capture of screen information 738. The programming that downloads the message information to the stamp unit preferably provides user controlled formatting of the bit image, such as on a separate pop up screen, before transmitting it for use on the stamp unit. Data may be collected by the programming in a textual format or a graphic format. When captured in a text format then the program allows the user to select font and printed textual attributes, such as size, bolding, underlining, and so forth.

FIG. 23 illustrates the underside 740 of stamp unit 712 with a grid of electrode pixels 742 distributed over the surface. The output voltage of these can be controlled by a row and column grid which controls the activation of a buried transistor for each pixel to drive it to the desired voltage, generally either a set voltage or a reset voltage. It will be appreciated that a number of techniques are known in the art for driving a collection of pixels to a desired state.

The base 744 of the stamp 712 is shown fabricated from insulating material from which conductive electrodes 746 extend to make contact with a buried common electrode.

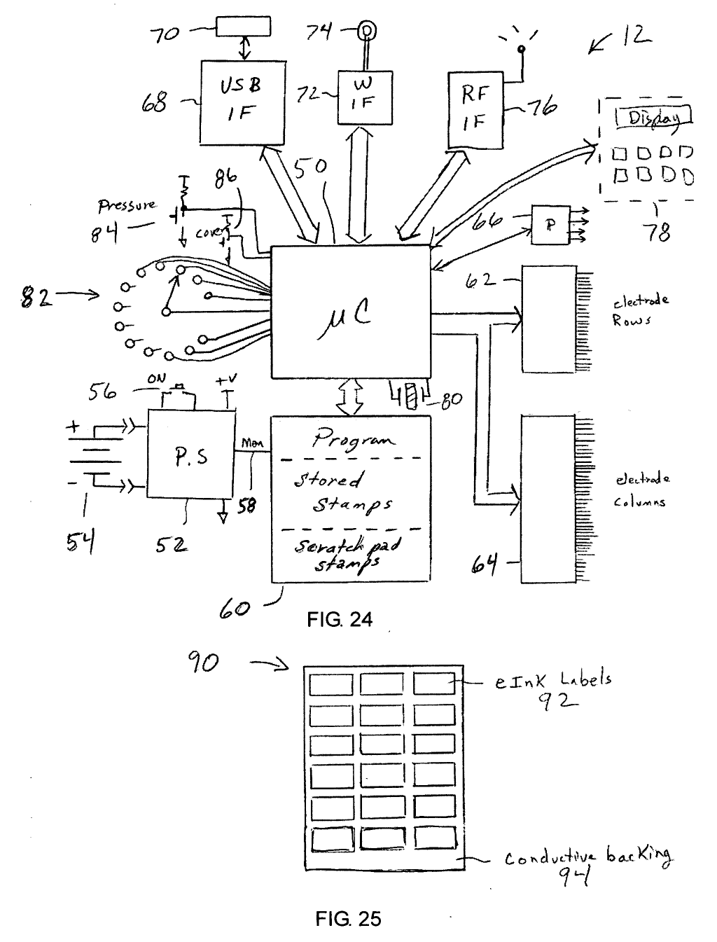

FIG. 24 illustrates an example embodiment of stamp unit 712, comprising a microprocessor 750 (or other control element which is preferably programmable) with a number of inputs and outputs. A power supply 752 is shown connected to a battery 754 or other form of power source, such as fuel cell, high capacity capacitor, photocells, etc. A power control switch 756 is shown for activating the unit for use. An optional power output 758 is shown connecting from the power supply to the memory 760, such as for retaining the contents in a non-volatile state when the power to the unit has been turned off. The memory 760 preferably retains microcontroller (uC) programming as well as stored stamp messages, and memory space for user programmed stamps and other features. Output for driving the pixel electrodes is exemplified by row and column drivers 762, 764 connecting to buried transistors or other means of producing a desired voltage at the pixel.

A power controller 766 is shown with multiple outputs for detecting the continuity between common electrode contacts and when programming to supply the desired voltage to all common electrode outputs.

A number of interfaces are shown for connecting to external equipment, such as a wired port 768 with connector 770, such as USB. The unit can be hardwared, such as through interface 772 and cable 774. A wireless connection can also be established, such as RF or infrared, herein an RF interface is depicted 776. Optionally, the unit can be configured with a full user interface 778, providing user inputs and/or display outputs. This user interface may be similar to that provided for a conventional ink based label printer. An audio annunciator 780 is preferably incorporated to signal stamp completion, errors, and other status information.

A multiposition message selector 782 is depicted for selecting messages contained within the memory of the unit. A switch 784 is shown for detecting user application of pressure in response to a “stamping” operation. A detect switch 786 is also shown for optionally detecting the presence of the electronic ink cover 732, wherein the operation of the unit preferably changes as described.

FIG. 25 depicts a sheet 790 of electronic ink labels 792 and a conductive backing sheet 794. Preferably the surface of the labels can be printed on conventionally, and areas unprinted by conventional means, such as open blocks can then be printed by the stamp unit, or other electronic ink printing means, such as otherwise described by the inventor.

### 4.5 Additional Aspects of the Invention.

A number of embodiments of the stamp unit can be implemented with a variety of features, which may be utilized separately or in combinations, the following being provided by example.

Date field—The stamp unit can be configured to independently retain a date (and optionally time), or to obtain a proper date when connected to a computer, or to obtain a time and date from a GPS time signal, or other RF timing signal, such as a widely distributed signal linked to an atomic clock. A message then can include a date field, wherein the message need not be changed for each date. A real-time clock can be coupled to a microprocessor for maintaining the proper date.

User ID—the date and time from the unit, can be utilized with a means for identifying each user, such as within a timecard system. For example, a thumbprint scan pad on the unit identifies the user when the stamp unit is grasped, wherein the date, time, and person is included in the stamp message output onto a time record containing electronic ink. The electronic information may be retained for downloading into a billing system, wherein both a paper record and electronic record is maintained. The user ID can also be utilized for controlling the use of device features. For example, only a given individual may utilize the unit for directly stamping postage to prevent unwarranted use in a corporate setting. This may be applicable to a mode in which the unit is configured to automatically generate a desired level of postage when a stamp impression is performed.

Field data from external device—other external devices can provide field data for use within a stamp message. For example, the stamp unit may be connected to a scale (wired or wireless) or a scale may be incorporated within the stamp unit. Electronic postage stamps are automatically created by the unit in the correct value to suit the weight category of the piece.

Series field—The stamp unit can be configured with a field that the microprocessor updates after each stamp impression. For example, a serial number field, which changes with each depression of the stamp by an amount set by the user.

List mode—A list of messages can be downloaded from a computer to the stamp unit, wherein with each stamp impression the next message in the list is selected. This mode is particularly well suited for stamping addresses on a number of envelopes from a contact list, contact manager, or similar program retaining an address list. A user input is preferably provided allowing the user to roll back to the previous element in the list in case a mistake is made during stamping.

Capture mode—a portion of a screen (either used in captured graphical format or captured as the associated textual or images) is marked for imprinting by the stamp. The area selected is then adjusted to fit the pixel of the stamp, for example a area of 400 pixels×150 may be selected, wherein the stamp unit may contain 200 pixels×100 pixels. Also the color range of the captured area is preferably adjusted to the electronic system utilized, typically monochrome. The modified image may be shown on the computer prior to downloading or output on the stamp unit with eInk cover as described above, wherein the user can see how the output will be rendered, wherein they can make changes to the masking color contrast and so forth to reach the desired result.

Voice Capture—in a few applications it may be desirable to capture voice commands and select or create an output image in response. A microphone and voice processing routines executing on a microprocessor, signal processor, and/or other processing element is required to provide this level of user interface. For example, upon pressing a input selector a text string can be received in voice and converted by the processor into a string of text for output by the stamp device.

### 4.6 Common Electrode.

The operations of the present stamp unit may be incorporated within electronic ink label printing devices previously described by the inventor such as described in patent application filed Jul. 1, 2003 sections 1-6, 9, and provisional patent application Ser. No. 60/394,160 filed Jul. 1, 2002, which are incorporated herein by reference.

The continuity testing between common electrodes which are pressed down to make contact with a possibly buried (overlying insulator) common electrode can be incorporated within the rolling wheel common electrode contactor, wherein the test is performed between contacts on the same wheel, or preferably between contact on two wheels. Signals are preferably generated while the electronic ink is being printed if continuity is lost. The test can be performed periodically, wherein instead of outputting on each contact, one contact is set to output with others set to input, wherein the connection can be checked, such as based on charging or discharging the input capacitance. In this way the programming voltage can be supplied while the user is given feedback as to how well they are making contact with the common electrode, for example to allow the user to modulate the pressure applied.

### 4.7 Programmed Inked Deposition Operations.

The reprogrammable stamp described in FIGS. 22-24 can also be configured for generating inked stamp imprints without substantially changing the design of the device. This mode allows the stamp to then be used on conventional material that do not have an electronic ink layer and a buried electrode layer.

It has not been fully appreciated in the creation of small portable stamping units that certain inks can be electrostatically charged, wherein they are repelled by a first polarity of charge and stick to surface containing a second polarity of charge.

In this embodiment of the invention a charged-aerosol inking station is provided for stamp unit. Once the stamp image has been selected the user places the stamp unit in the inker and activates inking. At that time the stamp electrodes are activated and the electrostatically charged ink is expelled as an aerosol within the base unit and adheres to a first portion of the pad of the stamp, while being repelled from other portions. Once inked the user pulls the unit from the inker and can make an inked impression on any material. The user can repeatedly charge and stamp the device if multiple impressions of the same image are needed. The image of the inked stamp is the image created from the pixels of the electrode array as programmed by the controller in response to user input.

It should be appreciated that if the user wishes to change the stamp image being inked, that the electrode area on the pad of the stamp must be thoroughly cleaned, such as with a cleaning wipe, before reinking the stamp in the base station.

An embodiment can be created which can be utilized for either electronic ink based materials without ink, or with ink for conventional materials.

### 5 Wireless Networking Backups.

### 5.1 Summary.

To provide a backup for wired services within a wireless infrastructure. Often critical information is communicated over a phone line, or cable line. For example, an emergency call to the police, an out dialing by a security system or surveillance system to communicate an intrusion detection to a remote security facility.

These wired services are vulnerable to attack by would-be intruders who first disable the telephone line or cable connection, along with possibly disrupting the power.

### 5.2 Buddy System.

The present invention utilizes a local wireless network for preventing this loss of communications resulting from damage to lines and loss of power.

The wireless network at a first location is configured to change to a mode that allows it to communicate with a second wireless network, such as that of a neighbor. In response to a loss of connection, the wireless network can request a connection through the neighbor with wired services, wherein the emergency call or emergency network traffic may be routed without disruption.

If the disruption is not limited to the one residence (or business building), then the request is appropriately denied. The wireless unit preferably records information about the emergency use that was made. Allowing emergency services by a neighbor is at the discretion of the user setting up the wireless network. It is prudent anyway for adjacent wireless users to establish policies that prevent overlap or unintended use of each others networks. While the system allows them to elect to help one another out in time of emergency.

Preferably the wireless networking unit utilizes a battery backed power supply so that power is maintained even if AC power is lost. Also if the phone is powered by the telephone line, then the wireless unit can be configured to detect the loss of

### 5.3 Wireless Telephone Network Backup.

A wireless telephone having a connector configured for establishing audio and microphone path connectivity, such as within a vehicle, is coupled to a switchover means connected to a wired connection. The switchover means being configured to connect to a wired phone line. Optionally the switchover unit is configured for generating power and ground to power the telephones connected to the internal wiring so that communication from wired phones to switchover device can take place. When a disconnection occurs the switchover device activates the wireless phone allowing the call to placed over wireless services from the wired telephone.

This connection may be utilized by conventional wired phones, or modem links, such as utilized for dialing out to communicate intrusions and other emergency situations.

### 5.4 Wired Line Fault Triggered Cutover.

Phone line entering the home, and not accessible to an intruder, is connected to a disconnection detection device providing isolation of interior and exterior wiring. Optionally this device can provide internal telephone voltages so that phone to phone communication may be maintained within the home (or business). The unit may generate ring voltages (preferably with a different cadence) on the network of phones within the home (business) and generate an audio announcement for users picking up the phone of the line disconnection, thereby warning of possible intrusion.

This unit may be configured with a wired ling directly to a wireless phone, or a wireless link through a base to which the wireless phone is connected.

### 5.5 Server Based Disruption Sensing/Cutover.

Similar to the third embodiment the incoming phone line connects to a server, such as a PC. All phones are connected to the server which is configured to generate telephone voltages, ringing and so forth. The server unit in many respects acts as a server. However, other services, such as a wireless phone, cable connection, or other is connected and may be automatically accessed upon the outside telephone connection being disrupted. The server can similarly generate ringing to alert persons that a disconnection has occurred.

Furthermore, disruption, even shorting of an individual phone within the inner network need not bring the network down as this condition is detected and the phone isolated, so long as phones are individually routed to the server.

### 5.6 Telephone Connection-Loss Annunciator

A phone system, wireless unit connecting to a wired service, separate unit, or other device or system, may be equipped for detecting when the telephone line has suffered a disconnection.

A circuit is configured for detecting a drop in the voltage across the phone line, while discriminating ringing, and temporary voltage changes which regularly occur. Additional tests on the line can be provided such as impedance to ground, because a fully open connection associated with a line being cut will generally either become an open circuit with extremely high impedance, or will be shorted together as a result of the damage occurring during the cutting process.

### 5.7 Embodiment of Crossover Device.

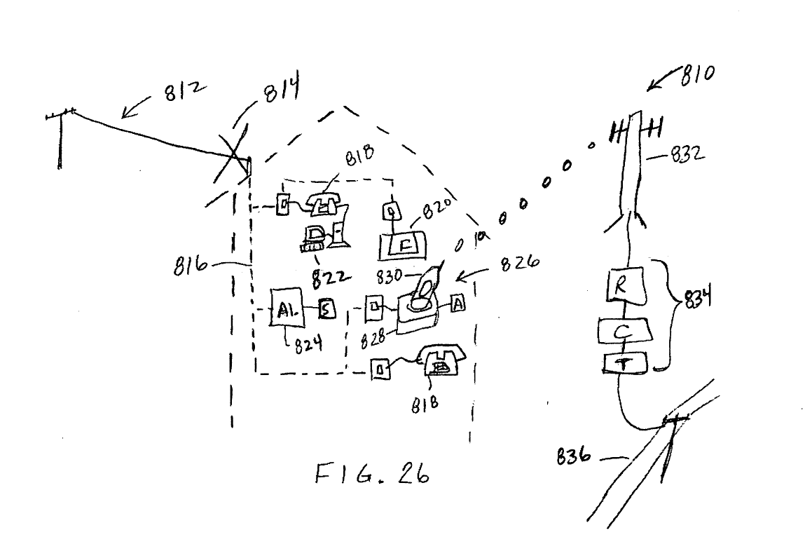

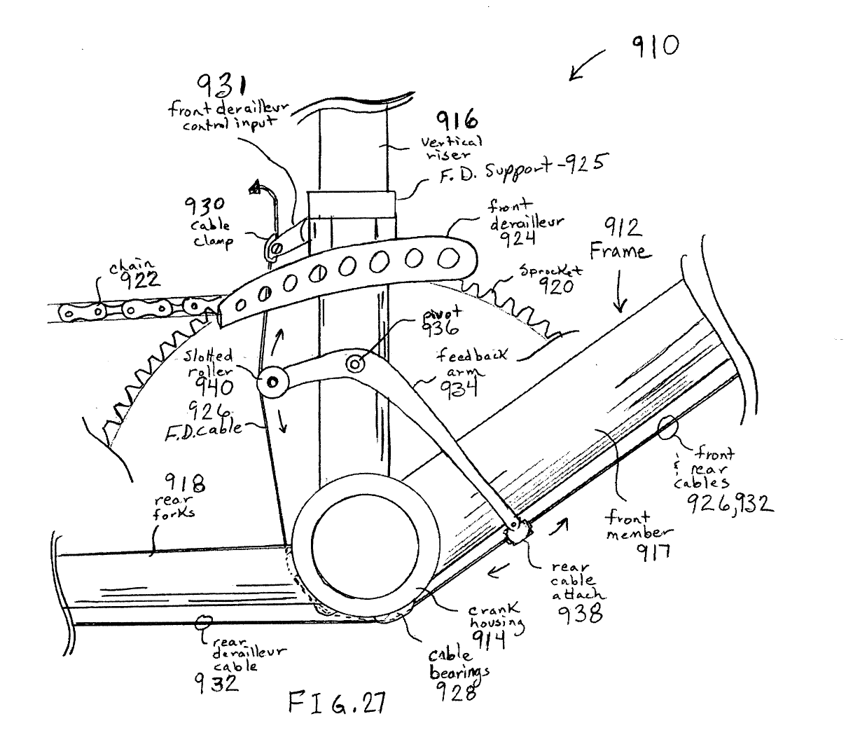

FIG. 26 illustrates by way of example an emergency phone system 810 within a home environment. A wired telephone connection 812 has been disrupted 814 into the home, such as by accident or intent, thereby isolating the small home phone interconnectivity network 816 and rendering the phones 818, FAX 820, DSL internet connectivity 822, as well as the alarm system 824 with sensors 825 wholly inoperative.

The present system is integrated within a cell phone system 826 comprising a base unit 828 that preferably provides a charger as well as a disruption detection, dialing detection and conversion, and outdialing connection through a wireless unit, such as wireless handset 830.

When a disruption is detected the wireless unit establishes connectivity through wireless infrastructure having antenna 832 coupled to phone equipment 834 which establishes a wireless connection with the destination, or more preferably a wired connection over telephone wiring 836.

### 5.8 Claim Descriptions.

The following are descriptions of this aspect of the invention written in a claim format.

1. A method of backing up wired services with wireless services within an overlapping wireless service environment, comprising:

(a) detecting a disruption in a first wired service connection by a first wireless device configured for connecting wirelessly to other wireless device, wireless infrastruction, or wireless telephone network;

(b) establishing connectivity from devices connected to said first wired service connection through said first wireless device; and

(c) bridging signals from the devices connected to said first wired service connection over said wireless connectivity to a desired destination.

2. A method as recited in claim 1, wherein said disruption may occur before or during an outgoing communication attempt on said first wired service.

3. A method as recited in claim 1, wherein said first wired service can comprise telephone or Internet connectivity.

4. A method as recited in claim 1, further comprising:

capturing dialing signals being directed at first wired device; and

outputting wireless dialing in response to captured wired device signaling.

5. A method as recited in claim 1, further comprising charging said wireless unit while retaining connectivity with a circuit for sensing said disruption and detecting digits directed at said wired service.

6 Front Derailleur with Rear Derailleur Position Feedback

### 6.1 Background.

Conventional derailleur systems utilize a front derailleur and a rear derailleur. The front derailleur moves the chain between two or three front sprockets of different diameters. The rear derailleur moves the chain between from five to eight gears of different diameters. Typically cables operate the derailleurs wherein pulling the cable on the front derailleur moves it toward higher gears (larger gears) and toward lower gears (larger gears) on the rear derailleur. These gears are operated independently wherein the user can change either the front or rear gear selection.

Originally derailleurs were controlled using two analog shifters wherein the user would move the shifter lever until the desired gear change occurred and then fine tune its position to reduce friction, generally as indicated by the amount of sound generated by the chain traversing the derailleur and gears. Shifting required “fidgeting” with the controls to get the shift to the proper location.

Often when the rear cluster was shifted, the position of the front derailleur was slightly adjusted to reduce friction and noise. It will be appreciated that the angle of the chain between the front and rear sprocket changes as the chain is moved from the lowest to highest gears on the rear gear cluster. As a result, the optimum positioning of the front derailleur depends on the positioning of the rear derailleur gearing.

Index shifting has become the standard mode of controlling gearing because it eliminates the need to fidget with the controls, the shifting clicks from one position to the next position shifting up, or shifting gears back down. The use of index shifting generally prevents the user from fine tuning the positioning of the gear trains. In many derailleur systems, especially those having more than five rear gears on the rear cluster, the front derailleur often does not stay (or even cannot be) properly adjusted and centered over the range of rear sprocket gear settings. Often the user is instructed just not to use the gears near the fringes of the range—however, this obviously reduces the utility of the gearing system. In order to minimize this loss of gear selections, the front derailleur designs are made less selective and efficient, but still the front derailleurs bind at select settings of the rear derailleur on large cluster systems.

### 6.2 Summary.

The present invention is a front derailleur control mixer mechanism that couples feedback from rear derailleur gear changes into the front derailleur to make minor correction to the adjustments. In this way the front derailleur is automatically adjusted in response to rear gearing changes. The cable, or other control input means, to control the rear derailleur gear is connected to a force redirection means, such as a lever, screw-shaft, or so forth, to adjust the front derailleur.

By way of example, the present invention describes gear shifting being performed through the use of cables, however, the present invention may be utilized with other forms of control without departing from the present invention.

The force redirection means of the invention may operate upon the cable connected to the front derailleur to change the tension within it, or it may be connected to the front derailleur mechanism itself to directly adjust the position of the front derailleur.

Additionally, the output from the rear derailleur shifter control can be connected through the front derailleur shifter control in which a mixer control couples a portion of the rear cable motion into the front cable motion. Any convenient mechanism may be utilized for mixing the rear gear select motion into the front derailleur select control motion, such as using mechanisms similar to those described herein, or any feedback injection device for instance those utilizing shifting pivot links, changing cable travel paths, gearing, and so forth.

It will be appreciated that the feedback into the front derailleur from the rear derailleur may be implemented using a number of alternative mechanisms, although those of the present invention are preferred.

### 6.3 Detailed Description of Embodiment.

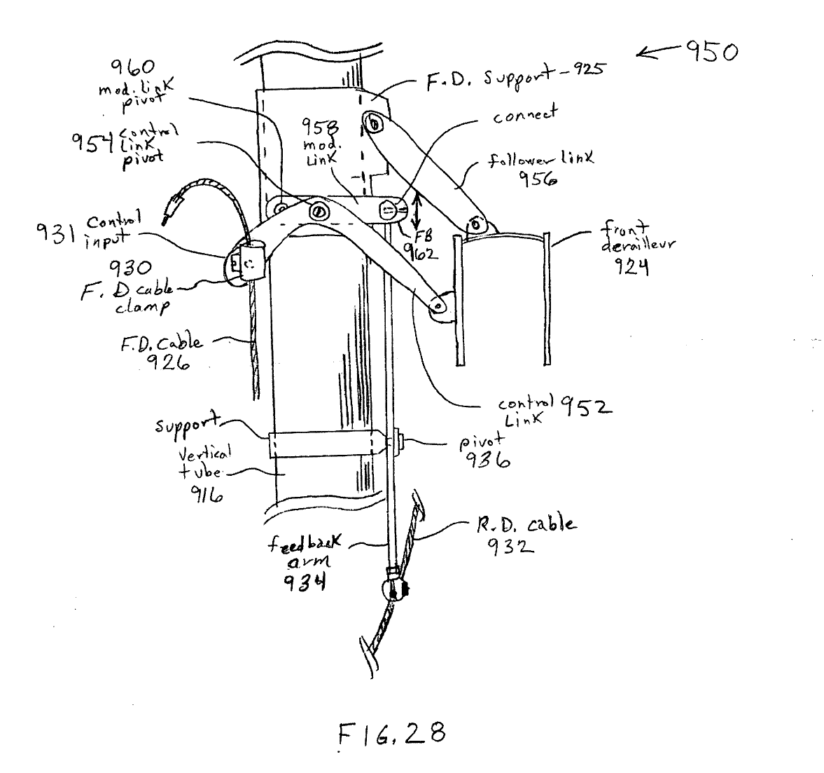

FIG. 27 illustrates an example of a front derailleur control mixer apparatus 910 shown on a bike frame 912 having crank housing 914 from which vertical riser 916 extends, front member 917 extends, and rear forks 918 extend. The partial outline of the exterior of the front sprocket 920 is shown (inner sprocket not shown) upon which a chain 922 is retained. A front derailleur 924 is shown connected to a support 925 attached to the vertical riser tube 916. A cable 926 for controlling the rear derailleur is shown routed under crank housing 914 in low friction slotted cable bearings 928 to redirect cable motion to cable clamp 930 on the control input 931 for controlling positioning of front derailleur 924. A cable 932 for controlling the rear derailleur (RD) is shown extending back past crank housing 914 along the rear forks 918.

The mixer device is exemplified as feedback arm 934 connected through pivot 936 with a proximal end having a cable connector 938 for attachment to the rear derailleur control cable 932, and a distal end configured with a means 940 for changing the path (tension) in the front derailleur cable, herein shown as a slotted roller wheel 940. It will appreciated that motion of the rear derailleur cable is coupled through the mixer to change the tension and thereby the positioning of the front derailleur. Changing the location at which the proximal end of feedback arm 934 connects to the cable alters the extent to which feedback is provided.

FIG. 28 illustrates another example embodiment 950, wherein the feedback from the rear cable is directed into the front derailleur mechanism instead of altering the cable path as exemplified in FIG. 27. Front derailleur 924 is shown positioned with a control link 952 through pivot 954 driven by control input 931. A follower link 956 is shown for keeping the derailleur substantially vertical along its travel.

A feedback means is depicted herein as a feedback link (modulator link) 958 with pivot 960. Pivot 954 of control link 952 is pivotally connected to feedback link 958 allowing the pivot point to be modulated in response to the motion of feedback input 962 which is coupled to feedback arm 934. In this example the motion of rear cable 932 moves feedback arm 934 through pivot 936 to move the end of feedback link 958 and the position of pivot 954 for control link 952 resulting in modulating the derailleur position in response to changing rear derailleur gear position as detected by changes in rear cable positioning.

### 6.4 Claim Descriptions.

The following are descriptions of this aspect of the invention written in a claim format.

1. A front derailleur, comprising:

a chain guide configured to selectably direct the position of a chain onto one of multiple geared sprockets;

a control input on said chain guide configured to connect to a front derailleur cable and to alter the position of said chain guide in response to the movement of said front derailleur cable; and

a feedback link configured for coupling to a rear derailleur cable from which motion is directed to slightly modulate the position of said chain guide.

2. An apparatus as recited in claim 1, wherein said feedback link has a first end configured for connection to said rear derailleur cable and a second end configured for interpositioning along the path of said front derailleur cable to modulate the path and associated tension applied by said front derailleur cable to said control input.

3. An apparatus as recited in claim 1, wherein said feedback link has a first end configured for connection to said rear derailleur cable and a second end coupled to said control input and/or said chain guide for modulating the position of said chain guide in response to the motion of said rear derailleur cable through said feedback link.

4. An apparatus as recited in claim 1, wherein said feedback link is configured with a cable clamp for connecting to said rear derailleur cable.

5. An apparatus as recited in claim 1, wherein said feedback link is configured with a rotating cable pulley for connecting to said rear derailleur cable.

6. In a front derailleur for changing the gear selection over which a chain is routed, the improvement comprising:

means of coupling feedback from the motion of the control linkage to the rear derailleur to modulate the position of said front derailleur.

### 6.5 Abstract

In the present invention, the motion of the cable for controlling the rear derailleur is fed into a mixer for the front derailleur to compensate for the angular change in position of the chain on the rear derailleur. In this way the front derailleur can operate smoothly over a wider angular range. The invention is particularly suited for index shifting systems that don't allow the user to fine tune the front derailleur position. By way of example, one end of a pivoting link is connected to the rear cable and on the other end is disposed a slotted wheel that presses on the front derailleur cable to change its path and tension in response to the motion of the rear derailleur.

### 7 Conclusion.

Throughout the specification numerous values and type designations may be provided for the elements of the invention in order that a complete, operable, embodiment of the invention be disclosed. However, it should be understood that such values and type designators are merely representative and are not critical unless specifically so stated. The scope of the invention is not limited to one or more specific exemplifications within a described embodiment.

Aspects of the present system and method may be implemented in a number of ways, however, the following is limited to descriptions of one or more preferred embodiments of the invention that may be readily practiced and easily understood. It should be appreciated, however, that one of ordinary skill in the art can modify these embodiments, especially in view of the teachings found herein, to implement a number of variations on the embodied invention without the need for creative effort and without departing from the teachings of the invention as described and/or claimed. The aspects, modes, embodiments, variations, and features described are considered beneficial to the embodiments described or select applications or uses; but are illustrative of the invention wherein they may be left off or substituted for without departing from the scope of the invention. Preferred elements of the invention may be referred to whose inclusion is generally optional, limited to specific applications or embodiment, or with respect to desired uses, results, cost factors and so forth which would be known to one practicing said invention or variations thereof.

Moreover, the various embodiments of the invention may be provided with all with all of features described herein, or only portions thereof, which combinations may be practiced and/or sold together or separately. For example, equipment may be manufactured and sold without certain desired equipment for later assembly. In this regard, such equipment may be “adapted to” include or otherwise couple to such equipment without departing from the intended scope hereof.

It should be appreciated that each aspect of the invention may generally be practiced independently, or in combinations with elements described herein or elsewhere depending on the application and desired use. Modes may be utilized with the aspects described or similar aspects of this or other devices and/or methods. Embodiments exemplify the modes and aspects of the invention and may include any number of variations and features which may be practiced with the embodiment, separately or in various combinations with other embodiments.

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

We claim:

1. A method of searching a collection of web sites for a user-supplied text search string, the search comprising:
(a) entering a search string by a user;
(b) activating text search programming or search engine acting upon a collection of web site information or web sites accessible on the Internet;
(c) text searching for said search string within the variable text field of a META tag reciting a specific ownership relation or association within the for text; and
(d) displaying information about web site in which search string was found in the variable text field of a META tag reciting a specific ownership relation or association, and information about the specific ownership relation or association that matched the search string entered by said user.

2. A method as recited in claim 1, further comprising selecting one or more ownership relationship or associations to which the search results for the user entered search string are to be responsive.

3. A method as recited in claim 2, wherein said search programming or engine is configured to search only META tag types reciting said one or more ownership relationships or associations.

4. A method as recited in claim 2, wherein said search engine programming or engine is configured to search META tag types reciting said one or more ownership relationship or associations along with other web site fields.

5. A method as recited in claim 1, wherein said search programming or engine is configured for generating search results which are ranked by how the search string matches with the variable text field within a META tag type that recites one or more of said selected ownership relationship or associations.

6. A method as recited in claim 1, wherein said search programming or engine is configured for generating search results wherein information displayed for web sites in which said user search string matched with the variable text field within a META tag type, reciting one or more of said selected ownership relationship or associations, contains information about the ownership relationship or association recited by the META tag.

7. An apparatus for directing the view of an imaging device, comprising:
a base member;
a plurality of segments having passageways near its periphery;
a mount for retaining an imaging device;
a plurality of muscle wire lengths attached to said base member and slidably threaded through said passageways from said in said plurality of segments and mechanically coupled to said mount;
wherein said segments strung on said muscle wire between said base and said mount form an elongated member;
wherein said base member is configured for coupling a current source to said muscle wire lengths for controlling the contraction of the muscle wire near the periphery of said elongated member regulating its curvature and the direction of said mount.

8. An apparatus as recited in claim 7, further comprising an imaging device attached to said mount.

9. An apparatus as recited in claim 7, wherein said muscle wire lengths comprise muscle wire loops t least two passageways.

10. A method of detecting an alarm condition, comprising the steps of:
(a) generating an alarm signal, from at least one detector unit within a plurality of detector units, in response to sensed conditions exceeding an alarm threshold;
(b) generating an alarm prequalification signal, from at least one detector unit within a plurality of detector units, in response to sensed conditions exceeding a prequalification threshold which is below said alarm threshold;
(c) outputting an alarm condition in response to receipt of at least one alarm signal from said detector units, or the receipt of a sufficient number of alarm prequalification signals from said detector units.

11. A method as recited in claim 10, wherein said prequalification threshold having a threshold below said alarm threshold is indicative that it has a higher probability of generating an output when an alarm condition does not actually exist, thereby the signal is not sufficient in itself to warrant an alarm but used as an alarm qualifier in combination with other conditions.

12. A method as recited in claim 10, wherein said sufficient number of prequalification signals comprises two prequalification signals.

13. A method as recited in claim 12:
further comprising generating discrete levels of prequalification signal in response to associated levels of prequalification threshold;
wherein said sufficient number of prequalification signals is determined by summing the received levels of prequalification signal.

14. A bicycle front derailleur, comprising:
a chain guide of a front derailleur configured to selectably direct the position of a chain onto one of multiple geared sprockets;
a control input on said chain guide configured to connect to a front derailleur cable and to alter the position of said chain guide in response to the movement of front derailleur cable; and
a feedback link configured for coupling to a rear derailleur cable from which motion is directed to slightly modulate the position of said chain guide in correcting the position of said chain guide of said front derailleur.

15. A front derailleur as recited in claim 14, wherein said feedback link has a first end configured for connection to said rear derailleur cable and a second end configured for interpositioning along the path of said front derailleur cable to modulate the path and associated tension applied by said front derailleur cable to said control input.

16. A front derailleur as recited in claim 14, wherein said feedback link has a first end configured for connection to said rear derailleur cable and a second end coupled to said control input and/or said chain guide for modulating the position of said chain guide in response to the motion of said rear derailleur cable through said feedback link.

17. A front derailleur as recited in claim 14, wherein said feedback link is configured with a cable clamp for connecting to said rear derailleur cable.

18. A front derailleur as recited in claim 14, wherein said feedback link is configured with a rotating cable pulley for connecting to said rear derailleur cable.

19. A front derailleur as recited in claim 14, wherein the feedback from said feedback link from said rear derailleur to said front derailleur, is sufficient to compensate for the change in position of the chain in response to gear changes at said rear derailleur.

20. A front derailleur as recited in claim 14, wherein said feedback link has a mechanical advantage wherein a large movement of the rear derailleur cable creates a small change in position of said chain guide of said front derailleur.

21. A method of finding web sites with a specific association with the search string, comprising:
(a) adding a META tag type to a web site for an organization or individual, said META tag reciting a specific ownership relation or association;
(b) adding descriptive text within the variable text field of said META tag that fulfills said specific ownership relation or association for said organization or individual; and
(c) making web site available for searching by search engines configured for searching said META tag type which recites the specific ownership relation or association.

22. A method of ranking web sites within search engine results based on a user-supplied search string, comprising:
(a) obtaining at least one list of information and/or ranking of entities associated with specified web sites, by a search engine supporting web site searches based on user-supplied search strings;
(b) adding search selection criterion on the search engine configured for receiving user selections which related to information from the list obtained; and
(c) listing web sites found during the search in an order responsive to information which was obtained from one of said lists.

23. An apparatus for directing the view of an imaging device, comprising:
an elongated flexible member configured for attaching an imaging device to a distal end; and
at least one muscle wire slidably engaged with at least one side of said elongated flexible member and configured to impart curvature to said elongated flexible member in response to contraction of said muscle wire as activation current is passed through said muscle wire.

24. An apparatus as recited in claim 23, wherein said slidably engagement comprises a sheath near the exterior of said elongated flexible member through which said muscle wire is passed and through which it can slide in response to changes in muscle wire length.

24. An apparatus as recited in claim 23, wherein the contraction of a single muscle wire flexes said elongated flexible member in opposition to the bias force produced by said flexible member itself.

25. An apparatus as recited in claim 23, wherein said at least one muscle wire comprises at least one muscle wire loop having two free ends at a first end configured for being physically retained and electrically connected to a source of current drive.

26. An apparatus as recited in claim 23, wherein two segments of muscle wire are slidably engaged on opposing sides of said elongated flexible member for inducing flexure of said elongated flexible member in the plane of said at two segments of muscle wire in response to current passed through said muscle wire.

27. An apparatus as recited in claim 23, wherein at least four segments of muscle wire are slidably engaged periodically about the periphery of said elongated flexible member for inducing flexure of said elongated flexible member in a direction in response to the differential current passed through the muscle wire segments.

28. An apparatus as recited in claim 23, wherein said elongated flexible member comprises stiff segments between which compressible material is retained allowing the elongated member to curve in response to applied forces.

29. An apparatus as recited in claim 28, wherein said stiff segments incorporate passageways through which said muscle wire is routed toward the exterior of said stiff segments.

30. An apparatus as recited in claim 23, further comprising:
an imager attached to the distal end of said elongated flexible member; a controller circuit to which said at least one muscle wire may be connected for receiving currents for controlling the direction to which said imager at the distal end of said elongated flexible member is directed; and
an image transformation device receiving image signals from said imager and configured to rotate images represented within said image signal in response to position signals from said controller circuit.

31. A system for generating intrusion alarms in response to registered conditions, comprising:
an intrusion detector configured for registering conditions indicative of intrusion;
an alarm detection circuit within said intrusion detector for generating an alarm signal in response to a condition, or conditions, which exceed a first threshold;
wherein said alarm detection circuit is configured to generate a prequalification signal in response to conditions which exceed a second threshold but which does not exceed said first threshold, and
a controller circuit configured for coupling to at least two said intrusion detectors and configured to generate an audible and/or silent alarm in response to detecting an alarm signal from any detector, or in response to the receipt of more than one prequalification signal.

32. A system as recited in claim 31, wherein said more than one prequalification signal must be generated from different intrusion detectors as a condition for generating said alarm.

33. A system as recited in claim 32, wherein said intrusion detector comprises means for unit identification within said system, allowing said controller circuit to distinguish which intrusion detector transmitted a given prequalification signal.

34. A system as recited in claim 31, wherein said controller circuit is configured to register the receipt of said prequalification signal and to extend the applicability of the prequalification over a predetermined or variable period of time when determining if more than one prequalification signal is being received.

35. In an alarm system having multiple sensor units coupled to a controller which generates an audible and/or silent alarm when an alarm conditions is communicated from one or more sensors, wherein the improvement comprises:
communicating a prequalification signal from said sensor units to said controller in response to detecting conditions which exceed a threshold below that necessary for generating an alarm; and
generating said audible and/or silent alarm in response to said controller receiving multiple prequalification signals.

36. In an alarm system having multiple sensor units coupled to a controller which generates an audible and/or silent alarm when an alarm signal is received from one or more sensors in response to sensed conditions exceeding an alarm threshold, wherein the improvement comprises:
communicating a prequalification signal from one of said sensor units to other sensor units in response to sensing conditions which exceed a threshold that is more sensitive to conditions than said alarm threshold; and
lowering the alarm detection threshold for said other sensor units in response to receipt of said prequalification signal, wherein said audible or silent alarm can be generated by said controller in response to conditions on any one single sensor that does not exceed said alarm threshold.

37. A system for generating intrusion alarms in response to registered conditions, comprising:
a plurality of intrusion detectors configured for registering conditions indicative of intrusion;
an alarm detection circuit within said intrusion detector for generating an alarm signal for conditions exceeding a first threshold;
a prequalification circuit within said alarm detection circuit which is configured to generate a prequalification signal in response to conditions which exceed a second threshold but which do not exceed said first threshold; and
a controller circuit coupled to said plurality of intrusion detectors and configured to generate an alarm in response to detecting an alarm signal from any detector, or in response to the receipt of more than one prequalification signal.

38. A system as recited in claim 37, wherein said more than one prequalification signal must be generated from different intrusion detectors as a condition for generating said alarm.

39. A system as recited in claim 38, wherein said intrusion detector comprises means for unit identification within said system, allowing said controller circuit to distinguish which intrusion detector transmitted a given prequalification signal.

40. A system as recited in claim 37, wherein said controller circuit is configured to register the receipt of a prequalification signal and to consider it as having extended forward for a predetermined period of time when determining if more than one prequalification signal is being received.

41. A method of generating an alarm signal in response to signals received by a controller from multiple detector units, comprising:
(a) registering conditions at one of a plurality of detector units;
(b) comparing said registered condition to an alarm threshold;
(c) generating an alarm signal if said registered condition crosses said alarm threshold;
(d) comparing said registered condition to a prequalification threshold signal if said registered condition did not cross said alarm threshold;
(e) generating a prequalification signal if said registered condition crossed said prequalification threshold; and
(f) generating an alarm signal in response to the receipt of a sufficient number of prequalification signals.

42. A method as recited in claim 41, wherein said prequalification threshold comprises a threshold between that of a nominal, non-alarm state, and said alarm threshold.

43. An apparatus for directing the view of an imaging device, comprising:
an elongated flexible member configured for attaching an imaging device to a distal end; and
at least one muscle wire slidably engaged with at least one side of said elongated flexible member and configured to impart curvature to said elongated flexible member in response to contraction of said muscle wire as activation current is passed through said muscle wire.

44. An apparatus as recited in claim 43, wherein said slidably engagement comprises a sheath near the exterior of said elongated flexible member through which said muscle wire is passed and through which it can slide in response to changes in muscle wire length.

45. An apparatus as recited in claim 43, wherein the contraction of a single muscle wire flexes said elongated flexible member in opposition to the bias force produced by said flexible member itself.

46. An apparatus as recited in claim 43, wherein said at least one muscle wire comprises at least one muscle wire loop having two free ends at a first end configured for being physically retained and electrically connected to a source of current drive.

47. An apparatus as recited in claim 43, wherein two segments of muscle wire are slidably engaged on opposing sides of said elongated flexible member for inducing flexure of said elongated flexible member in the plane of said at two segments of muscle wire in response to current passed through said muscle wire.

48. An apparatus as recited in claim 43, wherein at least four segments of muscle wire are slidably engaged periodically about the periphery of said elongated flexible member for inducing flexure of said elongated flexible member in a direction in response to the differential current passed through the muscle wire segments.

49. An apparatus as recited in claim 43, wherein said elongated flexible member comprises stiff segments between which compressible material is retained allowing the elongated member to curve in response to applied forces.

50. An apparatus as recited in claim 49, wherein said stiff segments incorporate passageways through which said muscle wire is routed toward the exterior of said stiff segments.

51. An apparatus as recited in claim 43, further comprising:
an imager attached to the distal end of said elongated flexible member;
a controller circuit to which said at least one muscle wire may be connected for receiving currents for controlling the direction to which said imager at the distal end of said elongated flexible member is directed; and
an image transformation device receiving image signals from said imager and configured to rotate images represented within said image signal in response to position signals from said controller circuit.

52. An apparatus for directing the view of an imaging device, comprising:
a base member;
a plurality of segments having passageways near its periphery;
a mount for retaining an imaging device;
a plurality of muscle wire lengths attached to said base member and slidably threaded through said passageways from said in said plurality of segments and mechanically coupled to said mount;
wherein said segments strung on said muscle wire between said base and said mount form an elongated member;
wherein said base member is configured for coupling a current source to said muscle wire lengths for controlling the contraction of the muscle wire near the periphery of said elongated member regulating its curvature and the direction of said mount.

53. An apparatus as recited in claim 52, further comprising an imaging device attached to said mount.

54. An apparatus as recited in claim 52, wherein said muscle wire lengths comprise muscle wire loops t least two passageways.

55. A system for generating intrusion alarms in response to registered conditions, comprising:
an intrusion detector configured for registering conditions indicative of intrusion;
an alarm detection circuit within said intrusion detector for generating an alarm signal in response to a condition, or conditions, which exceed a first threshold;
wherein said alarm detection circuit is configured to generate a prequalification signal in response to conditions which exceed a second threshold but which does not exceed said first threshold, and
a controller circuit configured for coupling to at least two said intrusion detectors and configured to generate an audible and/or silent alarm in response to detecting an alarm signal from any detector, or in response to the receipt of more than one prequalification signal.

56. A system as recited in claim 55, wherein said more than one prequalification signal must be generated from different intrusion detectors as a condition for generating said alarm.

57. A system as recited in claim 55, wherein said intrusion detector comprises means for unit identification within said system, allowing said controller circuit to distinguish which intrusion detector transmitted a given prequalification signal.

58. A system as recited in claim 55, wherein said controller circuit is configured to register the receipt of said prequalification signal and to extend the applicability of the prequalification over a predetermined or variable period of time when determining if more than one prequalification signal is being received.

59. In an alarm system having multiple sensor units coupled to a controller which generates an audible and/or silent alarm when an alarm conditions is communicated from one or more sensors, wherein the improvement comprises:
communicating a prequalification signal from said sensor units to said controller in response to detecting conditions which exceed a threshold below that necessary for generating an alarm; and
generating said audible and/or silent alarm in response to said controller receiving multiple prequalification signals.

60. In an alarm system having multiple sensor units coupled to a controller which generates an audible and/or silent alarm when an alarm signal is received from one or more sensors in response to sensed conditions exceeding an alarm threshold, wherein the improvement comprises:
communicating a prequalification signal from one of said sensor units to other sensor units in response to sensing conditions which exceed a threshold that is more sensitive to conditions than said alarm threshold; and
lowering the alarm detection threshold for said other sensor units in response to receipt of said prequalification signal, wherein said audible or silent alarm can be generated by said controller in response to conditions on any one single sensor that does not exceed said alarm threshold.

61. A method of detecting an alarm condition, comprising the steps of:
(a) generating an alarm signal, from at least one detector unit within a plurality of detector units, in response to sensed conditions exceeding an alarm threshold;
(b) generating an alarm prequalification signal, from at least one detector unit within a plurality of detector units, in response to sensed conditions exceeding a prequalification threshold which is below said alarm threshold;
(c) outputting an alarm condition in response to receipt of at least one alarm signal from said detector units, or the receipt of a sufficient number of alarm prequalification signals from said detector units.

62. A method as recited in claim 61, wherein said prequalification threshold having a threshold below said alarm threshold is indicative that it has a higher probability of generating an output when an alarm condition does not actually exist, thereby the signal is not sufficient in itself to warrant an alarm but used as an alarm qualifier in combination with other conditions.

63. A method as recited in claim 62, wherein said sufficient number of prequalification signals comprises two prequalification signals.

64. A method as recited in claim 63:
further comprising generating discrete levels of prequalification signal in response to associated levels of prequalification threshold;
wherein said sufficient number of prequalification signals is determined by summing the received levels of prequalification signal.

65. A system for generating intrusion alarms in response to registered conditions, comprising:
a plurality of intrusion detectors configured for registering conditions indicative of intrusion;
an alarm detection circuit within said intrusion detector for generating an alarm signal for conditions exceeding a first threshold;
a prequalification circuit within said alarm detection circuit which is configured to generate a prequalification signal in response to conditions which exceed a second threshold but which do not exceed said first threshold; and
a controller circuit coupled to said plurality of intrusion detectors and configured to generate an alarm in response to detecting an alarm signal from any detector, or in response to the receipt of more than one prequalification signal.

66. A system as recited in claim 65, wherein said more than one prequalification signal must be generated from different intrusion detectors as a condition for generating said alarm.

67. A system as recited in claim 66, wherein said intrusion detector comprises means for unit identification within said system, allowing said controller circuit to distinguish which intrusion detector transmitted a given prequalification signal.

68. A system as recited in claim 65, wherein said controller circuit is configured to register the receipt of a prequalification signal and to consider it as having extended forward for a predetermined period of time when determining if more than one prequalification signal is being received.

69. A method of generating an alarm signal in response to signals received by a controller from multiple detector units, comprising:
(a) registering conditions at one of a plurality of detector units;
(b) comparing said registered condition to an alarm threshold;
(c) generating an alarm signal if said registered condition crosses said alarm threshold;
(d) comparing said registered condition to a prequalification threshold signal if said registered condition did not cross said alarm threshold;
(e) generating a prequalification signal if said registered condition crossed said prequalification threshold; and
(f) generating an alarm signal in response to the receipt of a sufficient number of prequalification signals.

70. A method as recited in claim 69, wherein said prequalification threshold comprises a threshold between that of a nominal, non-alarm state, and said alarm threshold.

71. A method of backing up wired services with wireless services within an overlapping wireless service environment, comprising:
(a) detecting a disruption in a first wired service connection by a first wireless device configured for connecting wirelessly to other wireless device, wireless infrastruction, or wireless telephone network;
(b) establishing connectivity from devices connected to said first wired service connection through said first wireless device; and
(c) bridging signals from the devices connected to said first wired service connection over said wireless connectivity to a desired destination.

72. A method as recited in claim 71, wherein said disruption may occur before or during an outgoing communication attempt on said first wired service.

73. A method as recited in claim 71, wherein said first wired service can comprise telephone or Internet connectivity.

74. A method as recited in claim 71, further comprising:
capturing dialing signals being directed at first wired device; and
outputting wireless dialing in response to captured wired device signaling.

75. A method as recited in claim 71, further comprising charging said wireless unit while retaining connectivity with a circuit for sensing said disruption and detecting digits directed at said wired service.

76. In a front derailleur for changing the gear selection over which a chain is routed, the improvement comprising:
means of coupling feedback from the motion of the control linkage to the rear derailleur to modulate the position of said front derailleur.
